(19) United States
(12) Patent Application Publication
(10) Pub. No.: US 2026/0230105 A1
(43) Pub. Date: Aug. 6, 2026

(54) SYSTEMS, SUBSYSTEMS AND METHODS FOR CODING AND DECODING OF SIGNALS

(71) Applicant: ELBIT SYSTEMS C4I AND CYBER LTD., Netanya (IL)

(72) Inventors: Ezra ZAMIR, Netanya (IL); Shaul Baruch LAUFER, Netanya (IL)

(21) Appl. No.: 19/632,469

(22) Filed: Mar. 30, 2026

Related U.S. Application Data
(63) Continuation of application No. PCT/IL2024/051029, filed on Oct. 22, 2024.

(30) Foreign Application Priority Data
Oct. 26, 2023 (IL) 308048

(51) Int. Cl. H04B 1/692

(52) U.S. Cl. CPC H04B 1/692

(57) ABSTRACT

A transceiver subsystem comprising at least: a transmitter (Tx) subsystem configured to spread obtained data signals; a receiver (Rx) subsystem configured to receive and de-spread spread spectrum signals; and an illumination unit, comprising at least one light source, the illumination unit being configured to generate optical frequency combs (OFCs) and direct each OFC through one of at least two different optical paths, where the Tx Subsystem and the Rx subsystem use the same illumination unit and the same at least two OFCs, for both spreading and de-spreading of signals. A receiver subsystem for de-spreading of received spread spectrum signals that uses a synchronization subsystem having a pulse generator configured to introduce gating pulses into one of two optical paths; and a synchronization module configured at least to perform a search for determining a timing Tc of a correlation pulse, selecting at least one correlation pulse for de-spreading thereof.

### TECHNICAL FIELD

The present invention generally relates to the field of wireless communication that is based on spread spectrum signals (SSSs) and more particularly to spreading and/or de-spreading that is based on imprinting spectral terms of a spreading/de-spreading code.

### BACKGROUND

Radio-frequency (RF) wireless communication is used in numerous communication applications including cellular mobile devices communication, security communication applications and the like, typically limited to narrow RF spectral band(s), for avoiding or reducing interference with other RF based wireless communication networks. The allocated RF band(s) for each particular wireless network or communication type, introduces several problems including, inter alia, transmission speed and data reliability issues.

Spread spectrum techniques for wireless communication, especially RF based wireless communication, are commonly used, especially for avoiding/reducing interception and/or interference with other transmitted signals, while expanding the bandwidth restrictions of the network.

There are two general known spread spectrum communication techniques that are available:
(i) Frequency Hopping Spread Spectrum (FHSS) technique, according to which, the frequency of each transmitted signal is rapidly switched according to a predefined switching pattern (hopset). This technique is based on multiplexing of multiple different signals-to-be-transmitted (herein “transmission signals”) and allows transmission of multiple transmission signals simultaneously over the same transmission channel.
(ii) Direct Sequence Spread Spectrum (DSSS) technique, according to which each transmission signal is encoded by a spectral spreading code, using a predetermined chip code for modulating (spectrally spreading) of the transmission signal (herein “carrier signal”), where the decoding by the receiver is done based on the predetermined and known chip code.

The DSSS may be carried out by imprinting spectral terms of a spreading code (e.g., chip code) onto comb modes of the transmission signal, which may require decoding each received spread spectrum signal (SSS) by using the known spectral terms imprinted to the transmission signal. This imprinting technique can significantly improve coding and increase bandwidth being used (wider spreading), depending on the overall number of spectral terms being defined/used.

However, the spreading code imprinting technique requires a much faster signal processing and/or modulation, especially at the receiver (de-spreading/decoding) end and introduces significant noise rejection issues and challenges in synchronization between the timing of the spectral terms (chip code) imprinting and the timing of each received SSS.

### SUMMARY

Aspects of disclosed embodiments pertain to a receiver subsystem for de-spreading of at least one received spread spectrum signal (SSS), the receiver subsystem may include at least:
(i) an optical de-spreading subsystem (ODS) comprising at least:
an illumination unit, comprising at least one light source, configured to generate two optical frequency combs (OFCs) and direct each optical frequency comb (OFC) through one of two different optical paths;
a wave shaper, configured to imprint spectral terms of a spreading code onto comb modes of one of the signals propagated through one of the optical paths, producing thereby a coded optical frequency comb;
a first modulator, configured to mix each received SSS with the signal propagating through one of the two optical paths;
a mixing device, configured to mix output signals outputted from each of the two optical paths, outputting two optical output signals (OOSs);
two detectors, each configured to detect one of the two OOSs and output two corresponding electrical output signals (EOSs); and
(ii) a synchronization subsystem comprising at least:
a pulse generator configured to introduce gating pulses into one of the optical paths before entering the mixing device, producing thereby gating pulses corresponding to the EOSs that contain at least one correlation pulse; and
a synchronization module configured at least to:
receive and process pulses of the EOSs from the ODS;
perform a search for determining a timing of a correlation pulse Tc in the EOSs, within a search timeframe Δtₛ, at which a synchronization indication is obtained; and
select at least one correlation pulse, contained in the EOSs, corresponding to the timing Tc, at which the synchronization indication was obtained, wherein the selected at least one correlation pulse is the pulse selected for de-spreading thereof to at least one de-spread spectrum signal (DSS) of a narrower bandwidth than that of the SSS.

Other aspects of disclosed embodiments pertain to a method for de-spreading at least one received spread spectrum signal (SSS), the method comprising at least: receiving the at least one SSS;
generating two optical frequency combs (OFCs) and directing each OFC through one of two different optical paths;
imprinting spectral terms of a spreading code onto comb modes of one of the signals propagated through one of the optical paths, producing thereby a coded optical frequency comb;
mixing each received SSS with the signal propagating through one of the two optical paths;
mixing output signals outputted from each of the two optical paths, using a mixing device outputting two optical output signals (OOSs); and
detecting the two OOSs using two detectors producing thereby corresponding two electrical output signals (EOSs);
introducing periodic gating pulses, using a pulse generator, into at least one of the optical paths before entering the mixing device, producing thereby pulses corresponding to the EOSs that contain at least one correlation pulse; and
receiving and synchronizing de-spreading of the EOSs at least by:
performing a search for determination of timing of each correlation pulse Tc in the EOSs, within a timeframe Δtₛ until a synchronization indication is obtained; and
selecting at least one correlation pulse, contained in the EOSs, corresponding to the timing Tc, at which the synchronization indication was obtained, wherein each selected correlation pulse is the pulse selected for de-spreading thereof to a corresponding de-spread spectrum signal (DSS) of a bandwidth which is narrower than the bandwidth of the SSS.

Additional aspects of disclosed embodiments pertain to a transceiver subsystem for wireless communication comprising at least:
a transmitter (Tx) subsystem configured to spread obtained data signals (DSs) of frequency bandwidth BW1, generating spread spectrum signals (SSSs), each SSS having a higher frequency bandwidth BW2 than the frequency bandwidth BW1 of its corresponding obtained data signal (DS) and transmitting the generated SSSs;
a receiver (Rx) subsystem configured to receive SSSs, and de-spread received SSSs for achieving DSs of a narrower frequency bandwidth; and
an illumination unit, comprising at least one light source, the illumination unit being configured to generate optical frequency combs (OFCs) and direct each OFC or part thereof through one of at least two different optical paths.

According to some embodiments, the Tx Subsystem and the Rx subsystem use the same illumination unit and the same at least two OFCs generated by the illumination unit, for both spreading and de-spreading of signals, respectively.

According to some embodiments, the Tx subsystem and/or the Rx subsystem comprises an optical spreading and/or de-spreading subsystems, respectively.

In some embodiments, the transceiver subsystem may further include at least two splitters, wherein at least one splitter of the at least two splitters is configured to split a signal propagated via one of the at least two different optical paths and at least one other splitter of the at least two splitters is configured to split a signal propagated via a different optical path of the at least two different optical paths.

Additionally or alternatively, the transceiver subsystem may further include at least one wave shaper, each wave shaper being configured to imprint spectral terms of at least one spreading code or at least one de-spreading code onto comb modes of a signal propagated through at least one of the at least two different optical paths, producing thereby at least one coded optical frequency comb.

According to some embodiments, a single wave shaper may be used to generate a single coded optical frequency comb, which is then split for being fed to each of the Tx subsystem and the Rx subsystem, wherein the same code is used by the Tx subsystem and by the Rx subsystem.

According to other embodiments, ach of the Tx subsystem and the Rx subsystem uses a different wave shaper.

According to some embodiments, the Tx subsystem comprises a modulator configured to receive the data signal and mix it with a signal outputted by the at least one wave shaper or with an OFC propagated via one of the at least two different optical paths; and the Rx subsystem comprises a modulator configured to receive the SSS and mix it with a signal outputted by the at least one wave shaper or with an OFC propagated via one of the at least two different optical paths.

According to some embodiments, the Tx subsystem comprises a Tx mixing device, configured to mix signals outputted from each of the at least two different optical paths of the Tx subsystem, outputting at least two corresponding Tx optical output signals (OOSs); and the Rx subsystem comprises a Rx mixing device, configured to mix signals outputted from each of two different optical paths of the Rx subsystem, outputting at least two corresponding Rx OOSs.

Each of the Tx and the Rx mixing devices may include a 90 degrees optical hybrid device.

According to some embodiments, the Tx subsystem comprises at least two detectors each configured to detect one of the at least two OOSs outputted by the Tx mixing device and output two corresponding EOSs.

According to some embodiments, the Rx subsystem further comprises at least two detectors, each configured to detect one of the at least two OOSs outputted by the Rx mixing device and output two corresponding electrical output signals (EOSs).

According to some embodiments, the transceiver may further comprise a synchronization subsystem comprising:
(i) a pulse generator configured to introduce gating pulses into at least one of the at least two different optical paths before entering the mixing device, producing thereby gating pulses corresponding to the EOSs that contain at least one correlation pulse; and
(ii) a synchronization module configured at least to:
receive and process pulses of the EOSs;
perform a search for determining a timing Tc of a correlation pulse in the EOSs, within a search timeframe Δtₛ, at which a synchronization indication is obtained; and
select at least one correlation pulse, contained in the EOSs, corresponding to the timing Tc, at which a synchronization indication was obtained, wherein the selected at least one correlation pulse is the pulse selected for de-spreading thereof to at least one de-spread spectrum signal (DSS) of a narrower bandwidth than that of the SSS.

The synchronization module may be configured to perform an integration of the received EOSs pulses within each given integration timeframe ΔTi, for determining timing Tc of each correlation pulse, based on best signal strength, wherein ΔTi>Δtₛ.

The search performed may be at least one of:
a serial search wherein the integration is carried out in a serial manner for at least some hypothetic correlation timings Tc and the timing of an integration result that has provided the best signal strength, is selected as the timing of the correlation pulse to be de-spread; and
a parallel search where integration is carried out in a parallel simultaneous manner for at least two hypothetic correlation timings Tc and the timing of an integration result that has provided the best signal strength is selected as the timing of the correlation pulse to be de-spread.

According to some embodiments, the pulse generator is configured to generate gating pulses and is controllable by the synchronization module, and wherein the search is performed by shifting gating-timing of the gating pulses generated by the pulse generator, by a time step Tst, and performing the search for different gating-timings, until a synchronization indication is obtained.

According to some embodiments, the search is performed by adjusting one or more parameters of the spreading code.

According to some embodiments, the adjusting of the one or more properties of the spreading code comprises one or more of:
shifting timing of the spreading code; and/or
adjusting one or more parameters' values of one or more of the spectral terms of the spreading code being imprinted onto comb modes of the signal propagated through one of the at least two different optical paths, the one or more parameters' values being associated with phase and/or intensity of one or more of the spectral terms of the spreading code.

According to some embodiments, the spectral terms of the spreading code are Discrete Fourier Transform (DFT) terms of the spreading code, or a conjugation of DFT terms of the spreading code.

According to some embodiments, a frequency difference between each pair of adjacent tones of one of the two OFCs ΔF and the frequency difference between each pair of adjacent tones of the other OFC is at least ΔF+δf, such that ΔF≥N·δf, wherein “N” is an integer number larger than one, wherein δf is the bandwidth BW1 of the data signal, and wherein the bandwidth BW2 of the corresponding SSS is equal to or larger than N·δf.

According to some embodiments, the Rx subsystem further comprises two detectors configured to receive signals outputted from a mixing device of the Rx subsystem and at least two stretching devices configured to receive and stretch corresponding two signals outputted from the two detectors.

According to some embodiments, each stretching device comprises a low-pass filter (LPF), a balanced detector, or a convolution device configured for convolution of correlation pulses.

According to some embodiments the Tx subsystem is configured for double spreading of received DSs; and/or the Rx subsystem is configured for double de-spreading of received SSSs.

The Rx subsystem may further comprise a first optical de-spreading subsystem (ODS) for performing an initial de-spreading of received at least one radio-frequency (RF) double-spread spectrum signal of frequency bandwidth BW2, outputting a corresponding de-spread data signal (DDS) of an intermediate bandwidth BW_{IM} which is narrower than BW2, wherein a second de-spreader of the receiver subsystem is configured to receive and further de-spread the SS of intermediate bandwidth BW_{IM} to a de-spread signal of a final bandwidth BW1, which is narrower than the intermediate bandwidth BW_{IM} of the DDS.

Additionally or alternatively, the Tx subsystem may comprise a second spreader unit for receiving a firstly spread data signal, being spread by a first spreader outputting a first spread signal (SS) of an intermediate bandwidth BW_{IM} and further spreading the first SS to a final spread spectrum signal (SSS) of a bandwidth BW2 that is wider than that of the first SS WB_{IM}.

According to some embodiments, the illumination unit comprises at least one light source and one or more optical elements and/or devices, configured to split and/or direct light emanating from the at least one light source to be propagated via two different optical paths.

According to some embodiments, each OFC may be generated by using a different tunable optical frequency comb (TOC) device.

According to other aspect of disclosed embodiments, there is provided a method for wireless transmission and receiving of signals, the method comprising at least:
providing an illumination unit comprising at least one light source, wherein the illumination unit is configured to generate optical frequency combs (OFCs) and direct each OFC or part thereof through one of at least two different optical paths,
providing a transmission (Tx) subsystem and a receiver (Rx) subsystem;
obtaining, by the Tx subsystem, a data signal of a frequency bandwidth BW1;
generating a corresponding SSS, by the Tx subsystem, by spreading the obtained data signal, wherein the corresponding SSS is of a frequency bandwidth BW2, which is wider than frequency bandwidth BW1;
transmitting the generated corresponding SSS; and
receiving the transmitted SSS of frequency bandwidth BW2 and de-spreading it by the Rx subsystem, forming thereby a corresponding data signal of a frequency bandwidth BW1, which is narrower than BW2 of its corresponding SSS, wherein the method steps carried out by the Tx subsystem and by the Rx subsystem are carried out by using the same at least two OFCs generated by the illumination unit, for both spreading and de-spreading of signals, respectively.

According to some embodiments, the method may further include using at least two splitters, wherein at least one splitter of the at least two splitters, is configured to split a signal propagated via one of the at least two different optical paths and at least one other splitter of the at least two splitters is configured to split a signal propagated via a different optical path of the at least two different optical paths.

The method may also include imprinting spectral terms of at least one spreading code or at least one de-spreading code onto comb modes of a signal propagated through at least one of the at least two different optical paths, producing thereby at least one coded optical frequency comb, using at least one wave shaper.

According to some embodiments, a single wave shaper may be used to generate a single coded optical frequency comb, which is then split for being fed to each of the Tx subsystem and the Rx subsystem, wherein the same code is used by the Tx subsystem and by the Rx subsystem.

Each of the Tx subsystem and the Rx subsystem may use a different wave shaper.

According to some embodiments, the Tx subsystem comprises a modulator configured to receive the data signal and mix it with a signal outputted by the at least one wave shaper or with an OFC propagated via one of the at least two different optical paths; and the Rx subsystem comprises a modulator configured to receive the SSS and mix it with a signal outputted by the at least one wave shaper or with an OFC propagated via one of the at least two different optical paths.

According to some embodiments, the Tx subsystem comprises a Tx mixing device, configured to mix signals outputted from each of two different optical paths of the Tx subsystem, outputting at least two corresponding Tx optical output signals (OOSs); and the Rx subsystem comprises a Rx mixing device, configured to mix signals outputted from each of two different optical paths of the Rx subsystem, outputting at least two corresponding Rx OOSs.

Each of the Tx and the Rx mixing devices may include a 90 degrees optical hybrid device.

According to some embodiments, the Tx subsystem comprises at least two detectors each configured to detect one of the at least two OOSs outputted by the Tx mixing device and output two corresponding EOSs.

According to some embodiments, the Rx subsystem further comprises:
two detectors, each configured to detect one of the at least two OOSs outputted by the Rx mixing device and output two corresponding electrical output signals (EOSs); and/or
a synchronization subsystem comprising:
(i) a pulse generator configured to introduce gating pulses into at least one of the at least two different optical paths before entering the mixing device, producing thereby gating pulses corresponding to the EOSs that contain at least one correlation pulse; and
(ii) a synchronization module configured at least to:
receive and process pulses of the EOSs;
perform a search for determining a timing Tc of a correlation pulse in the EOSs, within a search timeframe Δtₛ, at which a synchronization indication is obtained; and
select at least one correlation pulse, contained in the EOSs, corresponding to the timing Tc, at which a synchronization indication was obtained, wherein the selected at least one correlation pulse is the pulse selected for de-spreading thereof to at least one de-spread spectrum signal (DSS) of a narrower bandwidth than that of the SSS.

According to some embodiments, the synchronization module is configured to perform an integration of the received EOSs pulses within each given integration timeframe ΔTi, for determining timing Tc of each correlation pulse, based on best signal strength, wherein ΔTi>Δtₛ.

According to some embodiments, the search performed is at least one of:
a serial search wherein the integration is carried out in a serial manner for at least some hypothetic correlation timings Tc and the timing of an integration result that has provided the best signal strength, is selected as the timing of the correlation pulse to be de-spread; and
a parallel search where integration is carried out in a parallel simultaneous manner for at least two hypothetic correlation timings Tc and the timing of an integration result that has provided the best signal strength is selected as the timing of the correlation pulse to be de-spread.

According to some embodiments, the pulse generator is configured to generate gating pulses and is controllable by the synchronization module, and wherein the search is performed by shifting gating-timing of the gating pulses generated by the pulse generator, by a time step Tst, and performing the search for different gating-timings, until a synchronization indication is obtained.

The search may be performed by adjusting one or more parameters of the spreading code.

According to some embodiments, the adjusting of the one or more properties of the spreading code comprises one or more of:
shifting timing of the spreading code; and/or
adjusting one or more parameters' values of one or more of the spectral terms of the spreading code being imprinted onto comb modes of the signal propagated through one of the at least two different optical paths, the one or more parameters being associated with phase and/or intensity of one or more of the spectral terms of the spreading code.

According to some embodiments, the spectral terms of the spreading code are Discrete Fourier Transform (DFT) terms of the spreading code, or a conjugation of DFT terms of the spreading code.

According to some embodiments, a frequency difference between each pair of adjacent tones of one of the two OFCs ΔF and the frequency difference between each pair of adjacent tones of the other OFC is at least ΔF+δf, such that ΔF≥N·δf, wherein “N” is an integer number larger than one, wherein δf is the bandwidth BW1 of the data signal, and wherein the bandwidth BW2 of the corresponding SSS is equal to or larger than N·δf.

According to some embodiments, the Rx subsystem further comprises two detectors configured to receive signals outputted from a mixing device of the Rx subsystem and at least two stretching devices configured to receive and stretch corresponding two signals outputted from the two detectors.

Each stretching device may include a low-pass filter (LPF), a balanced detector, or a convolution device configured for convolution of correlation pulses.

According to some embodiments, the Tx subsystem is configured for double spreading of received DSs; and/or the Rx subsystem is configured for double de-spreading of received spread spectrum signals (SSSs).

According to some embodiments, the Rx subsystem further comprises a first de-spreader unit comprising an ODS for performing an initial de-spreading of received at least one radio-frequency (RF) double-spread spectrum signal (SSS) of frequency bandwidth BW2, outputting a corresponding de-spread data signal (DDS) of an intermediate bandwidth BW_{IM} which is narrower than BW2, wherein a second de-spreader of the receiver subsystem is configured to receive and further de-spread the DDS; and/or wherein the Tx subsystem comprises a second spreader unit for receiving a firstly spread signal, being spread by a first spreader outputting a first SS of an intermediate bandwidth BW_{IM} and further spreading the first SS to a final spread spectrum signal (SSS) of a bandwidth BW2 that is wider than that of the first SS WB_{IM}.

According to some embodiments, the illumination unit comprises at least one light source and one or more optical elements and/or devices, configured to split and/or direct light emanating from the at least one light source to be propagated via two different optical paths.

According to some embodiments, each OFC is generated by using a different designated tunable optical frequency comb (TOC) device.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a block diagram, schematically illustrating a wireless communication system using a receiver with a synchronization subsystem for synchronized optical de-spreading of received spread spectrum signals, according to some embodiments;

FIG. 2 is a block diagram, schematically illustrating a receiver subsystem, using a double optical path illumination unit, for generation of two optical frequency combs (OFCs), where the receiver subsystem is configured for optical imprinting of a spreading code onto one of the generated OFCs, and a synchronization subsystem for synchronizing de-spreading of each received SSS that is based on controlled generation and introduction of gating pulses into one of two optical paths, according to some embodiments;

FIG. 3 schematically illustrates main devices/modules of a synchronization subsystem for optical de-spreading of received spread spectrum signals, according to some embodiments;

FIG. 4 is a block diagram, schematically illustrating a receiver subsystem, using a double optical path laser light source for generation of optical frequency combs (OFCs), according to some embodiments, and a synchronization subsystem for synchronizing de-spreading of each received SSS that is based on code imprinting adjustment/control, according to other embodiments;

FIG. 5 is a block diagram, schematically illustrating a transmitter subsystem, using two generated OFCs for spreading of an incoming or generated RF data signal (modulated carrier or baseband signal), according to some embodiments;

FIG. 6 is a block diagram, schematically illustrating a receiver subsystem, using two generated OFCs for de-spreading (decoding) of an incoming RF data signal, and a synchronization subsystem that is based on gating pulses generation and spreading code imprinting control, according to some embodiments;

FIGS. 7A and 7B show block diagrams, schematically illustrating a double spreading transmitter and a double-de-spreading receiver of a wireless communication system for ultra spread spectrum signals (SSSs) communication of a very broad bandwidth: FIG. 7A shows a transmitter using a first spreader configured to generate and spread a RF data signal of an initial narrow de-spread bandwidth BW1 into a spread signal of an intermediate bandwidth BW_{IM}>BW1 and a second optical spreader configured to further spread the intermediate spread signal into a spread spectrum signal of a bandwidth BW2>BW_{IM}>BW1; and FIG. 7B shows a receiver using a first optical de-spreader configured to de-spread each received SSS of a bandwidth BW2 into an intermediate de-spread signal of an intermediate bandwidth BW_{IM}<BW2 and a second de-spreader configured to further de-spread the intermediate spread signal into a de-spread signal of a bandwidth BW1<BW_{IM}<BW2;

FIG. 8, is a flowchart, schematically illustrating a process for synchronized de-spreading of a received SSS, according to some embodiments;

FIGS. 9A and 9B schematically illustrate double stage spreading and de-spreading processes, according to some embodiments: FIG. 9A illustrates a double-stage spreading process; and FIG. 9B illustrates a double-stage de-spreading process;

FIG. 10 schematically illustrates main devices/modules of a synchronization subsystem for optical de-spreading of received spread spectrum signals, also capable of receiving feedback data from a second (digital) de-spreader, according to some embodiments;

FIG. 11 is a block diagram, schematically illustrating main components of a transceiver subsystem enabling using an illumination unit with a single mutual laser light source that can be used for both a spreading subsystem and a de-spreading subsystem, according to some embodiments;

FIG. 12 is a block diagram, schematically illustrating main components of a transceiver subsystem enabling using a single mutual laser light source and a single mutual wave shaper that can be used for both a spreading subsystem and a de-spreading subsystem, according to some embodiments; and

FIG. 13, is a flowchart, schematically illustrating a process for using a same mutual laser light source that is configured to generate two different (shifted) frequency optical combs (OFCs) for being utilized simultaneously by both a receiver and transmitter subsystem, according to some embodiments.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

Aspects of disclosed embodiments, pertain to systems, modules, subsystems, receivers, transmitters and methods for wireless communication based on spread spectrum signals (SSSs) for corresponding coding and decoding of wirelessly transmitted and/or received SSSs.

According to some embodiments, the spreading of each generated RF data signal (carrier transmission signal) to form a SSS that is to be transmitted by a transmitter of a wireless communication system, may be a very wide range spread signal (e.g., up to or more than 10 GHz), by using a process that spreads an original RF data signal of a narrow bandwidth BW1 (typically less than 1 GHz) multiple times in a graduated (cascading) manner, using one or more types of spreading techniques into a spread spectrum signal (SSS) of a much broader bandwidth of BW2: BW2>>BW1 (e.g. where BW2 is close to 10 GHz). According to embodiments of this system, each received SSS may also be de-spread, at a receiver's end, by using one or more de-spreaders, modules and/or techniques. Several manners in which an original narrow band RF signal may be spread and/or de-spread in a multi-stage (cascaded) manner, may include using an optical subsystem for optically imprinting a set of spectral terms onto the original RF data signal or an optical signal corresponding to the RF data signal, are taught in IL patent number IL285982 and its corresponding PCT application publication number WO2023031903, which are incorporated herein by reference in their entirety.

Other aspects of disclosed embodiments, pertain to de-spreading methods, systems, receivers, receiver subsystems etc. for de-spreading any type of SSS also using a synchronization subsystem for synchronizing imprinting spectral terms of a spreading code with the timing of each received SSS.

Aspects of disclosed embodiments, pertain to systems, subsystems, units, modules and/or methods for improved de-spreading of received spread spectrum signals (SSSs) of a spread spectrum bandwidth of BW2 to de-spread spectrum signals (DSSs) of a much narrower bandwidth BW1, where BW2>>BW1, by using signal processing that is at least partially optical, to improve signal processing speed and de-spreading accuracy and quality.

According to some embodiments, the receiving/communication system, receiver, and/or receiver subsystem includes using one or more synchronization subsystems and/or modules that are based on introduction of gating pulses into one of two optical paths for synchronizing the de-spreading of each received SSS by searching of corresponding “correlation” gating pulse(s) properties (such as timing or duration) that is synchronized with the one or more imprinting properties of the imprinted spectral terms.

According to some embodiments, there is provided a receiver subsystem for de-spreading of at least one received SSS of a (broad) frequency bandwidth BW2, where the receiver subsystem may include at least:
(i) an optical de-spreading subsystem (ODS) comprising at least:
an illumination unit that uses at least one light source configured to generate two optical frequency combs (OFCs) and direct each OFC through one of two different optical paths;
a wave shaper (WS), configured to imprint spectral terms of a spreading code onto comb modes of one of the signals propagated through one of the optical paths;
a first modulator, configured to mix each received SSS with the signal propagating through one of the two optical paths;
a mixing device (such as a 90-degrees optical hybrid device), configured to mix output signals outputted from each of the two optical paths, outputting two optical output signals (OOSs);
two detectors, each configured to detect one of the two OOSs and output two corresponding electrical output signals (EOSs); and
(ii) a synchronization subsystem comprising at least:
a pulse generator configured to introduce optical pulses into one of the optical paths before entering the mixing device, producing thereby pulses corresponding to the EOSs that contain at least one correlation pulse; and
a synchronization module configured at least to:
receive and process pulses of the EOSs from the ODS at least by performing a search for determining a timing of at least one correlation pulse Tc in the EOSs, within a search timeframe Δtₛ, at which a synchronization indication is obtained, and selecting at least one correlation pulse, contained in the EOSs, corresponding to the timing Tc, at which the synchronization indication was obtained. The selected at least one correlation pulse may be the pulse selected for de-spreading thereof to at least one de-spread spectrum signal (DSS) of a bandwidth BW1, which is narrower than BW2.

According to some embodiments, the synchronization may include performing an incoherent integration of the received EOSs pulses within each given integration timeframe ΔTi, for determining timing Tc of each correlation pulse, wherein ΔTi>Δtₛ. The determination of the timing Tc of each correlation pulse may be based on maximal signal strength and/or signal-to-noise-ratio (SNR).

According to embodiments, one of the OFCs may be used for duplication of the received SSS within the comb's frequencies and the other OFC may be used as a local oscillator for shifting and coding copies of the signal of the first (other) OFC to generate the spread signal.

According to some embodiments, the search may include performing a serial search for identifying/obtaining a synchronization indication. The timing of each correlation pulse Tc may be determined based on comparing result of the incoherent integration of multiple EOSs pulses to at least one predefined threshold value and/or by searching for a best (e.g., maximal) signal strength.

According to other embodiments, the search may include a combined serial and parallel search where incoherent integration is carried out in parallel (e.g., simultaneously) for several hypothetic correlation timings Tc for each signal being searched in the serial search and the integration result that has provided the best (maximal or that exceeds a threshold) strength is selected as the correlation signal to be de-spread.

According to some embodiments, the pulse generator may be configured to generate gating pulses and is controllable by the synchronization module, where the search is performed by shifting gating-timing of the gating pulses generated by the pulse generator, by a time step Tst, and performing the serial search for different gating-timings, until a synchronization indication is obtained.

According to other embodiments, the search may be performed by adjusting one or more properties of the spreading code, by, for example, by performing one or more of:
shifting imprinting timing of the spreading code; and/or
adjusting one or more parameters' values of one or more of the spectral terms of the spreading code being imprinted onto comb modes of the signal propagated through one of the optical paths, the one or more parameters being associated with phase and/or intensity of one or more of the spectral terms of the spreading code.

According to other embodiments, the synchronization may be done based on received synchronization information such as based on received synchronization timing and/or SSS duration and beginning, obtained by pre-processing of the received SSS, e.g., in case of a double de-spreading subsystem from a second (additional) de-spreader performing further de-spreading (whether optical or electronical/digital) of the signal outputted from the optical de-spreader.

The spectral terms of the spreading code may be Discrete Fourier Transform (DFT) terms of the spreading code, or a conjugation of DFT terms of the spreading code.

The receiver subsystem may also include at least two stretching devices such as two low-pass filters (LPFs), configured to receive and stretch corresponding two EOSs outputted from the two detectors in the time domain.

According to some embodiments, the pulse generator may be controllable by the synchronization module. In this case, the search may be performed by shifting gating-timing of the periodic gating pulses generated by the pulse generator, e.g., by a predetermined time step Tst, and repeating the serial search until a synchronization indication is obtained.

The receiver subsystem may be part of a receiver including other components such as a receiving antenna, etc.

According to some embodiments, the receiver subsystem may be part of a wireless transceiver system configured for both receiving, de-spreading and decoding SSSs as well as for generation, spreading and transmission of SSSs, using the same laser light source for generating the same two OFCs for both spreading of each signal to be transmitted and de-spreading of each received SSS.

Additionally or alternatively, the receiver subsystem may be part of a receiver unit for wireless communication, wherein the receiver unit further comprises a second de-spreader unit for de-spreading of received at least one stretched signal, from the first (optical) de-spreader, of a frequency bandwidth BW_{IM} which is narrower than the frequency bandwidth BW2 of its corresponding SSS, and further de-spread each received stretched signal, outputting a corresponding double de-spread data signal of bandwidth BW1, which is narrower than BW_{IM}.

According to some embodiments, the synchronization subsystem may be configured to determine timing Tc of each correlation pulse, based at least on timing of the corresponding double de-spread data signal, received from the second de-spreader.

Aspects of disclosed embodiments pertain to a method for de-spreading at least one received SSS of a frequency bandwidth BW2, that may include at least:
receiving the at least one input signals of SSS;
generating two optical frequency combs (OFCs) and directing each OFC through one of two different optical paths;
imprinting spectral terms of a spreading code onto comb modes of one of the signals propagated through one of the optical paths, producing thereby a coded optical frequency comb;
mixing each received SSS with the signal propagating through one of the two optical paths;
mixing output signals outputted from each of the two optical paths, using a mixing device outputting two optical output signals (OOSs); and
detecting the two OOSs using two detectors producing thereby corresponding two electrical output signals (EOSs);
introducing periodic gating pulses, using a pulse generator, into at least one of the optical paths before entering the mixing device, producing thereby pulses corresponding to the EOSs that contain at least one correlation pulse; and
receiving and synchronizing de-spreading of the EOSs at least by performing a search for determination of timing of each correlation pulse Tc in the EOSs, within a timeframe Δtₛ until a synchronization indication is obtained, and selecting at least one correlation pulse, contained in the EOSs, corresponding to the timing Tc, at which the synchronization indication was obtained, wherein each selected correlation pulse is the pulse selected for de-spreading thereof to a corresponding de-spread spectrum signal (DSS) of a bandwidth BW1, which is narrower than BW2.

A “correlation pulse” may be defined as an output EOS, outputted from each of the detectors, that correlates with the received SSS to be de-spread such that the timing of a beginning and/or timespan of the electrical output signal (EOS) correlates with the beginning and/or timespan of the corresponding SSS and defined as the determined/identified “correlation pulse timing” Tc. The correlation pulse contains the accumulated power of the chips of a spread symbol, so that its SNR is maximal at its peak.

According to some embodiments, the laser light source may generate continuously the two OFCs (e.g., by using a continuous wave (CW) light source split into two comb-generators), such that in order to synchronize the imprinting timing with the received SSS timing:
(i) the pulses generated by the pulse generator of the synchronization subsystem may be gating pulses for controllable selection of signals of one of the OFCs, while the imprinting timing is not controlled and set to a preset timing and order; OR
(ii) the pulse generator outputs similar/same pulses at a preset pulsation rate, while the timing of the imprinting of the spreading code is controllable (e.g., by controlling the wave shaper operation).

According to other embodiments, the received SSS to be de-spread is of a very wide bandwidth and may be first de-spread by a first optical de-spreader, outputting a (time domain) stretched signal of an intermediate bandwidth BW_{IM}, which is narrower than the bandwidth BW2 of the SSS, a second de-spreader may be used to further de-spread the received stretched signal. In these cases, the synchronization may be additionally or alternatively based on input information/data from this second de-spreader.

According to some embodiments, the bandwidth BW2 of each SSS may be of a frequency bandwidth of ΔF, which may be equal to or larger than a multiplication of a bandwidth BW1=δf of the de-spread signal such that ΔF≥N·δSf, wherein “N” is an integer number larger than 1. The frequency difference between each pair of adjacent tones of one of the two OFCs may also be equal to ΔF and the frequency difference between each pair of adjacent tones of the other OFC may be larger than ΔF by a shift of δf such that the difference between each pair of adjacent tones of the other OFC may be equal to or larger than ΔF+δf.

Disclosed embodiments, enable de-spreading/decoding of multi-spread incoming SSSs of a frequency bandwidth of up to and/or higher than 10 GHz (Giga-Hertz).

Disclosed embodiments further enable providing an improved (increased) processing gain (such as improved SNR) and/or processing speed, as well as improved (reduced) processing-complexity and/or error-probability.

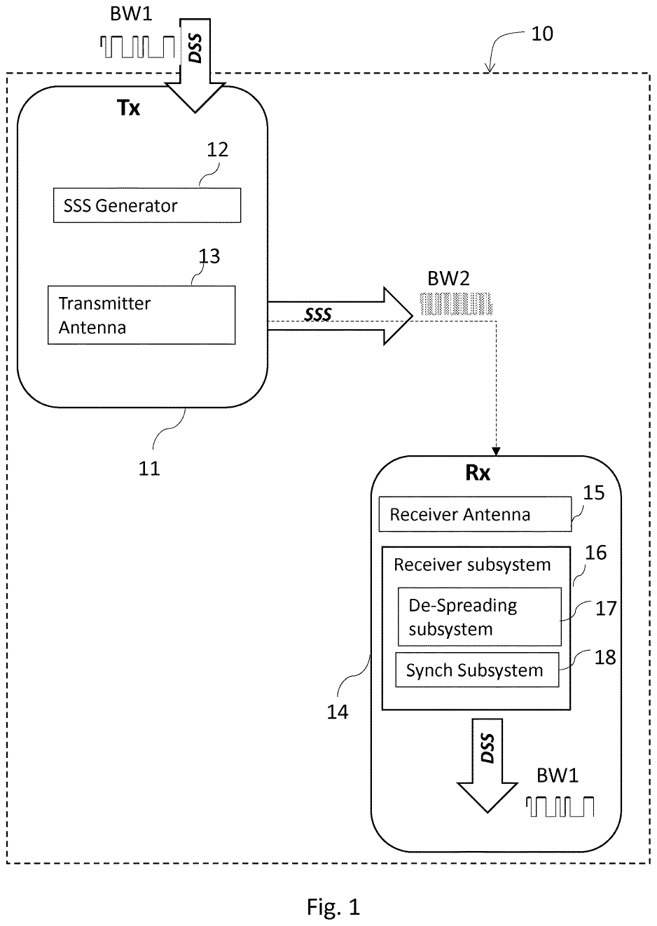

Reference is now made to FIG. 1, schematically illustrating general components of a wireless communication system 10 that is based on spectral spreading that uses a synchronization subsystem 18 for synchronized de-spreading of received SSSs, according to some embodiments. This wireless communication system 10 includes:
a transmission unit 11 configured to generate and transmit SSSs of bandwidth BW2; and
a receiving unit 14, configured to receive SSSs and de-spread each received SSS, outputting a corresponding de-spread spectrum signal (DSSs).

According to some embodiments, the transmission unit 11 may include a SSS generator 12 configured for generating SSSs, and at least one transmission antenna such as transmission antenna 13 for wireless transmission of SSSs.

According to some embodiments, the SSS generator 12 may be configured to generate an initial RF signal of a narrow bandwidth and spread the generated initial RF signal using one or more spreaders for transforming the initial RF signal into a SSS (e.g., also in the RF spectral range).

According to some embodiments, the receiving unit 14 may include:
one or more receiving antennas such as receiving antenna 15, configured for receiving transmitted SSSs from the transmission unit 11 and/or from other transmitters;
a receiver subsystem 16, configured to de-spread each received SSS of bandwidth BW2 to transform it into a corresponding DSS of a narrower bandwidth of BW1<BW2.

According to some embodiments, the receiver subsystem 16 may include:
a de-spreading subsystem 17 that is configured for optical de-spreading of each received SSS, where the optical de-spreading is based on spreading code (chip code) imprinting; and
a synchronization subsystem 18 configured to synchronize the de-spreading process based on searching for correlation pulses timing Tc.

According to some embodiments, the de-spreading subsystem 17 may be configured to:
generate two optical frequency combs (OFCs) and directing each OFC through one of two different optical paths;
imprint spectral terms of a spreading code onto comb modes of one of the signals propagated through one of the optical paths, producing thereby a coded optical frequency comb;
mixing each received SSS with the signal propagating through one of the two optical paths;
mix output signals outputted from each of the two optical paths, using a mixing device outputting two optical output signals (OOSs); and
detect the two OOSs using two detectors producing thereby corresponding two electrical output signals (EOSs).

The synchronization subsystem 18 may be configured to:
introduce gating pulses, e.g., by using a pulse generator, into at least one of the optical paths before entering the mixing device, producing thereby pulses corresponding to the EOSs that contain at least one correlation pulse; and
receive and synchronize de-spreading of the EOSs at least by performing a search for determination of timing of each correlation pulse Tc in the EOSs, within a timeframe Δtₛ until a synchronization indication is obtained, and selecting at least one correlation pulse, contained in the EOSs, corresponding to the timing Tc, at which the synchronization indication was obtained, wherein each selected correlation pulse is the pulse selected for de-spreading thereof to a corresponding DSS of a narrower bandwidth BW1.

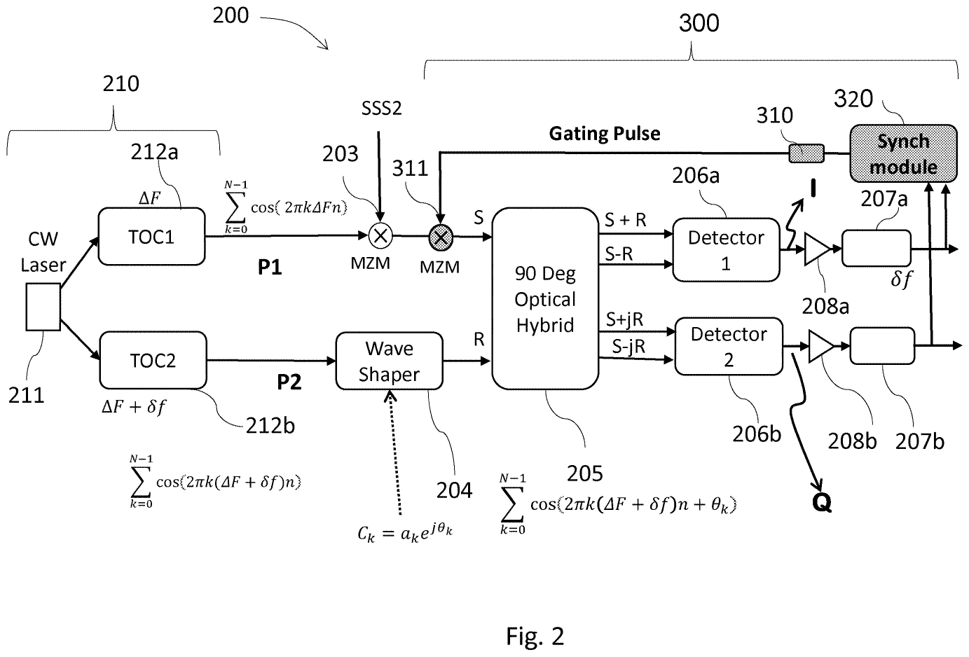

Reference is now made to FIG. 2, schematically illustrating a receiver subsystem 200, according to some embodiments, that includes a synchronization subsystem 300 that is based on controllable gating pulses generation. The receiver subsystem 200 may include:
an laser light source 210 including a light source 211 such as a CW laser and two tunable optical (frequency) comb (TOC) devices such as a first TOC device 212a and a second TOC device 212b, for generating corresponding two different OFCs: a first OFC OFC1 and a second OFC OFC2, where the laser light source 210 may also include one or more optical elements and/or devices for splitting light emanating from the light source 211 and/or for directing light from the light source 211 to each of the TOC devices 212a and 212b such as optical fibers (not shown), defining thereby a first optical path (FOP) P1 and a second optical path (SOP) P2;
a first optical modulator such as a first Mach Zehnder Modulator (MZM) 203 positioned over the FOP P1 and configured to introduce received signals (which include one or more SSSs) into the first OFC OFC1;
a wave shaper (WS) 204 configured to imprint a predefined spreading code into the second OFC OFC2;
a 90-degrees optical hybrid device 205 configured and positioned to receive signals S and R, outputted by each of the optical paths FOP and SOP (e.g., via different input ports thereof) and mix these signals (e.g., by integration and reduction thereof) such as to output two pairs of separate signals: a first pair of: M1=S+R and M2=S−R; and a second pair of: M3=S+jR and M4=S−jR;
two detectors such as: a first balanced detector 206a positioned and configured to receive the first signal pair S1 and S2; and a second balanced detector 206b positioned and configured to receive the second signal pair S3 and S4 and output two corresponding EOSs: EOS1 and EOS2;
two corresponding amplifiers 208a and 208b;
two corresponding stretching devices 207a and 207b configured to receive and stretch corresponding two EOSs EOS1 and EOS2, outputted from the two balanced detectors 206a and 206b; and
a synchronization subsystem 300 for synchronization between the received SSS timing and the spreading code imprinting timing that is based on controllable gating pulse generation.

The first OFC OFC1 may have a frequency separation of ΔF, where ΔF≥N·δf (N>1):

$${\sum }_{k = 0}^{N - 1} {e}^{j ( 2 π k ( Δ F ) n )}$$

The second OFC—OFC2, may have a frequency separation of ΔF+δf:

$${\sum }_{k = 0}^{N - 1} {e}^{j ( 2 π k ( Δ F + δ f ) n )}$$

Where the frequency-domain spreading coefficients can be expressed by:

$${C}_{k} = {a}_{k} {e}^{j {θ}_{k}}$$

where: k is an integer index number: k=1, . . . n, where “n” is an integer number larger than 1: n>1.

The wave shaper 204 may be controlled by controlling frequency domain coefficients Cₖ obtained from the time domain spreading code Cₙ.

According to these embodiments, as shown in FIG. 2, the synchronization subsystem 300 may include:
a pulse generator 310 configured to controllably generate gating optical pulses;
a second (additional) modulator such as a second MZM 311 configured and positioned to introduce gating pulses generated by the pulse generator 310, into the signal propagated through the FOP P1 (in this case, to the signal as outputted from the first MZM 203 corresponding to the mixed first OFC and received signal(s)); and
a synchronization module 320 configured to control the pulse generator 310 for selection of correlation pulse(s) for de-spreading of synchronized SSSs.

According to some embodiments, the gating pulses are periodic pulses with a period of 1/(BW_{IM}) and pulse width of between 1/(BW2) to 2/(BW2) where BW_{IM} is the chip rate of the first spread signal and BW2 is the chip rate of the second spread signal, where BW_{IM}<BW2.

The code may be imprinted to the second OFC—OFC2 propagated through the SOP P2 via the wave shaper 204, such that the signal inputted into one of the input ports of the 90-degrees optical hybrid device 205 is a coded OFC2.

The 90-degrees optical hybrid device 205 also receives signals outputted from the FOP P1, which is the mixing/modulation of the first OFC—OFC1 with the received SSS, gated by the gating pulse. The 90-degrees optical hybrid device 205 may be a six-port device (two input and four output ports), configured to mix the two received signals outputted from the two optical paths P1 and P2, which, together with the two balanced detectors, enable detection of properties such as amplitude and phase of the unknown received signal SSS. The 90-degrees optical hybrid device 205 outputs four signals:

$$M 1 = S + R$$

$$M 2 = S - R$$

$$M 3 = S + jR$$

$$M 4 = S - jR$$

where S represents the signal outputted from the FOP P1 and R represents the reference signal received from the SOP P2, such that:
S can be expressed by:

$${s}_{n} \cdot {\sum }_{k = 0}^{N - 1} {e}^{j ( 2 π k ( Δ F + δ f ) n )}$$

R can be expressed by:

$${\sum }_{k = 0}^{N - 1} {a}_{k} \cdot {e}^{j ( 2 π k ( Δ F ) n - {θ}_{k} )}$$

The purpose of the 6-ports 90-degrees optical hybrid device 205 is to generate a 90° phase shift between its I and Q output components, and 180° phase shift between balanced detectors 206a and 206b.

Each stretching device 207a/b may include a low-pass filter (LPF), each LPF may be configured to stretch the overall energy/intensity/power of each signal outputted from the balanced detectors 206a and 206b and amplifiers 208a and 208b, over a symbol pulse (time) duration for achieving the desired output signal of the desired narrower bandwidth BW_{IM}.

Alternatively, each signal may be stretched (in the time domain) by using processing means of the synchronization module 320, serving as a digital filter, for convoluting the pulses. Convolution may be done by expanding the correlation pulses in time, such that each pulse duration is stretched to a full symbol period by using a convolution (mathematical) operation, which combines the correlation pulses with at least one function such as a rectangular signal function, for stretching each pulse to a symbol-equivalent pulse duration. In this case the receiver subsystem 200 does not include the two stretching devices 207a and 207b. In some cases, the LPFs may be used for further filtering/modification/smoothing/stretching of the stretched pulses.

The de-spread signal may be expressed by:

$$S \cdot {R}^{*} = {s}_{n} \cdot {\sum }_{k = 0}^{N - 1} {e}^{j ( 2 π k ( δ f ) n + {θ}_{k} )} = {s}_{n} \cdot {\sum }_{k = 0}^{N - 1} {C}_{k} {e}^{j ( 2 π k ( δ f ) n )} = {s}_{n} \cdot {c}_{n}$$

According to some embodiments, the 90-degrees optical hybrid device 205 performs optical multiplication, integration and/or reduction of the received comb signals, for obtaining complex representation(s) of the received SSS.

The signals M1-M4, outputted from the 90-degrees optical hybrid device 205 may then be detected by using the two balanced detectors 206a and 206b, such that M1 and M2 are detected by the first balanced detector 206a and M3 and M4 are detected by the second balanced detector 206b. Signals outputted from the balanced detectors 206a and 206b may be amplified by amplifiers 208a and 208b and then stretched/filtered by the two corresponding stretching devices 207a and 207b, where each stretching device 207a and/or 207b may include a low-pass filter (LPF).

According to some embodiments, the outputted stretched signals (also referred to herein as electrical output signals EOSs), outputted from the stretching devices 207a and 207b, may then be used, inter alia, for the synchronization process, by being split such that portion of each EOS will be also processed by the synchronization module 320. The synchronization module 320 may be configured to perform a non-coherent (incoherent) integration of these EOSs, within a timeframe ΔTi corresponding (e.g., equal to) an estimated time-cycle of a correlation pulse, and perform a serial search using the balanced detectors 206a and 206b, in order to identify/detect/obtain a synchronization indication and its corresponding timing Tc of the correlation pulse(s). The timing of the gating pulsing controllably outputted from the pulse generator 310, may be adjusted for a duration corresponding to this timeframe of ΔTi and the incoherent integration results may be measured for several such timeframes, until a synchronization indication is obtained.

According to some embodiments, a synchronization indication may be identified/obtained/determined by determining a value of a power/intensity related parameter that is associated with the resulting incoherent integration, and either looking for an extremum (such as maximum) value thereof or determining a distance of this value to a predefined threshold value of the same parameter and determining a minimum achievable distance as the criteria for synchronization identification or indication obtainment. For example, the parameter being determined may be signal-strength, where a maximal signal-strength between all integration results may comply with a maximum signal strength criterion for synchronization obtainment. Alternatively, the distance between the determined signal-strength of each integration and a threshold signal-strength value THss may be calculated/determined and the integration result providing a minimal value of such distance (from all integrations made and their corresponding integration results) is determined as the one corresponding to the correlation EOS and its timing Tc is obtained/recorded and synchronized by controlling the gating pulsing accordingly.

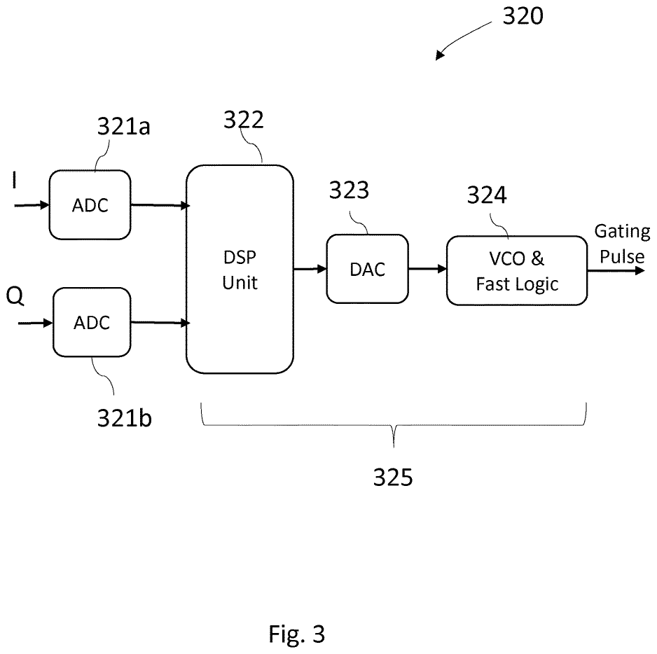

FIG. 3 schematically illustrates at least some main parts and configuration of the synchronization module 320, according to some embodiments. The synchronization module 320 may include at least:
two complex analogue-to-digital converters (ADCs) such as a first analogue-to-digital (ADC) 321a configured to receive signals outputted from the first stretching device 207a and a second ADC 321b configured to receive signals outputted from the second stretching device 207b; and
a search unit 325 that may include one or more digital and/or analogue hardware and/or software configured to receive output signals, outputted from the two ADCs 321a and 321b, and perform a serial search for the determination of the timing Tc of each correlation pulse.

According to some embodiments, the search unit 325 may include, for example:
a digital signal processing (DSP) unit 322;
a digital-to-analogue converter (DAC) 323;
a voltage-controlled oscillator (VCO) 324 that may use or include fast-logic hardware and/or software.

The components 322-324 may be operatively associated with one another in a manner that enable conducting the serial search and incoherent integration of the EOSs and may also be configured to control at least timing of the gating pulses by controlling the pulse generator 310.

According to some embodiments, the synchronization module 320 may be configured to receive the de-spread signals outputted for stretching devices 207a and 207b, search for the peak of correlation through non-coherent integration of hypotheses of peak timing and control the pulse generator 310 by controlling gating-timing.

Alternatively, the DSP unit 322 of the synchronization module 320 may be configured to directly receive the signals outputted from the 90 degrees optical hybrid device 205 (e.g., after being amplified by amplifiers 208a and 208b) and operate a convolution operator to perform the signal-stretching.

According to some embodiments, the gating time may correspond to the frequency-width of the correlation pulse. For example, the gating timespan may be: Gt=1/(N·δf), where the gating time may be shifted by steps of 1/(2·N·δf).

The gating period (timespan) may be proportional or equal to

$$\frac{N}{N \cdot δ f} = \frac{1}{δ f} .$$

For example, for a SSS of spreading within the range of 100 MHz-10 GHz, the gating timing may be of 100 psec (pico-second), the gating period may be of 10 nsec (nano-second) and the shift step may be of 50 psec.

The synchronization module 320 may be designed to find a best timing of the correlation pulse. The pulse duration may be equal to or smaller than the chip duration of the SSS.

Repetition rate may be equal to the chip duration of the de-spread signal (which may be affected by Doppler shifts).

A time gating may be used to filter out noise from the correlation pulse, based on the following general steps:
at each gating time, performing incoherent integration of a predefined number of several first spreading chips (e/g/. several thousands) in order to build/obtain a significant SNR for achieving probability values for detection;
if a predefined threshold is exceeded, the acquisition ceases and a “tracking process is initiated and performed;
if the threshold is not exceeded the gating timing is further controlled (e.g., by controlling the pulse laser of the pulse generator 310).

According to some embodiments, the tracking process may be performed in order to maintain the correct timing of the correlation pulse at the output of the receiver subsystem 200

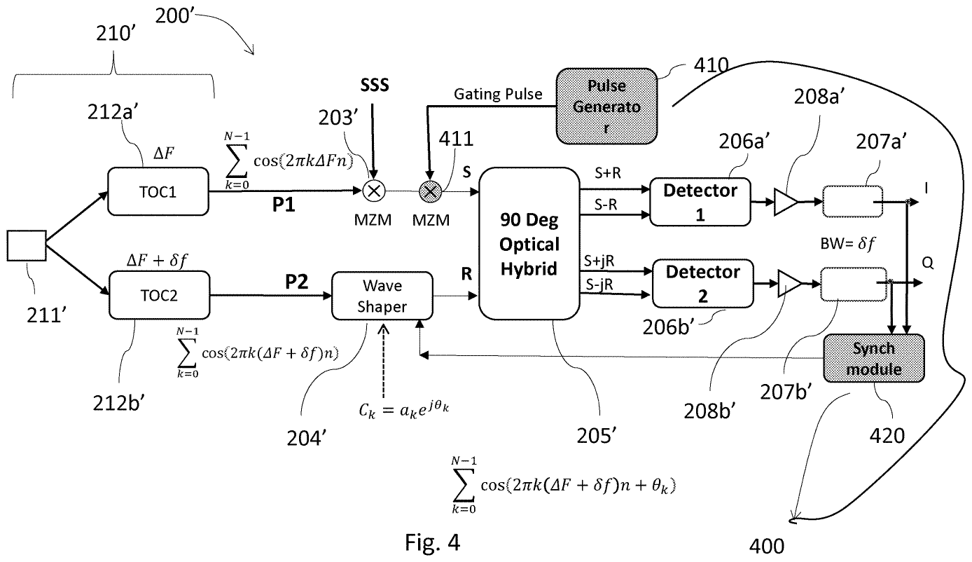

Reference is now made to FIG. 4, schematically illustrating a receiver subsystem 200′, according to other embodiments, that includes a synchronization subsystem 400 that is based on wave shaper 204′ control. The receiver subsystem 200′ may include:
an illumination unit 210′ including a light source 211′ such as a CW laser and two tunable optical frequency comb (TOC) devices such as a first TOC device 212a′ and a second TOC device 212b′, for generating corresponding two different OFCs: a first OFC OFC1 and a second OFC OFC2, where the illumination unit 210′ may also include one or more optical elements and/or devices for splitting light emanating from the light source 211′ and/or for directing light from the light source 211′ to each of the TOC devices 212a′ and 212b′ such as optical fibers (not shown), defining thereby a first optical path (FOP) P1 and a second optical path (SOP) P2;
a first optical modulator such as a first Mach Zehnder Modulator (MZM) 203′ positioned over the FOP P1 and configured to introduce received signals (which include one or more SSSs) into the first OFC OFC1;
a wave shaper (WS) 204′ configured to imprint a predefined spreading code into the second OFC OFC2;
a 90-degrees optical hybrid device 205′ configured and positioned to receive signals S and R, outputted by each of the optical paths FOP and SOP (e.g., via different input ports thereof) and mix these signals (e.g., by integration and reduction thereof) such as to output two pairs of separate signals: a first pair of: M1=S+R and M2=S−R; and a second pair of: M3=S−jR and M4=S−jR;
two detectors such as: a first balanced detector 206a′ positioned and configured to receive the first signal pair S1 and S2; and a second balanced detector 206b′ positioned and configured to receive the second signal pair S3 and S4 and output two corresponding EOSs: EOS1 and EOS2;
two corresponding amplifiers 208a′ and 208b′;
two corresponding stretching devices 207a′ and 207b′ such as two LPFs, each configured to receive and stretch a corresponding different EOS from EOS1 and EOS2, outputted from the two detectors 206a′ and 206b′; and
a synchronization subsystem 400 for synchronization between the received SSS timing and the spreading code imprinting timing that is based on controllable gating pulse generation.

According to these embodiments, as shown in FIG. 4, the synchronization subsystem 400 may include:
a pulse generator 410 configured to generate repeated optical pulses;
a second (additional) modulator such as a second MZM 411 configured and positioned to introduce pulses generated by the pulse generator 410, into the signal propagated through the FOP P1 (in this case, to the signal as outputted from the first MZM 203′ corresponding to the mixed first OFC and received signal(s)); and
a synchronization module 420 configured to control spreading code imprinting and/or timing thereof by controlling the wave shaper 204′.

In these embodiments, the gating pulses introduced to the signal propagated through the FOP P1, are of the same timing and properties and they are introduced into the FOP P1 in a repeated manner of a predetermined constant pulsing rate, where the timing of the comb propagated through SOP P2 timing is controllable for the synchronization thereof by controlling/adjusting timing and/or other properties of spectral terms of the spreading code such as phase/or amplitude value of each spectral term of the spreading code.

The serial search may be performed, in this case, by repeatedly iterating the following steps for each serial search:
adjusting one or more parameter values of each of the spectral terms being imprinted onto comb modes of the second OFC—OFC2 that propagates through the SOP P2 such as phases, amplitudes and/or intensities of the comb modes of the second OFC—OFC2 (by controlling the wave shaper 204′); and
measuring the value of a criterion related parameter such as the signal strength (at the synchronization module 420) of EOSs outputted from the stretching devices 207a′ and 207b′.

The synchronization may be done, in this case, by identifying one of the adjustments made to the second OFC—OFC2 that yielded corresponding incoherent integration of the EOSs that is of maximal signal strength or exceeds a predetermined threshold THss.

The 90-degrees optical hybrid device 205′ may be a six-port device (two input and four output ports), configured to mix the two received signals outputted from the two optical paths P1 and P2. The 90-degrees optical hybrid device 205′ outputs four signals:

$$M 1 ’ = S + R$$

$$M 2 ’ = S - R$$

$$M 3 ’ = S + jR$$

$$M 4 ’ = S - jR$$

where S represents the signal outputted from the FOP P1 and R represents the reference signal received from the SOP P2.

The 90-degrees optical hybrid device 205′ generates a 90° phase shift between its I and Q output components.

As mentioned above, one or more of the receiver subsystems described herein may be part a wireless communication system that may be based on multiple (such as double) cascaded spreading and/or multiple de-spreading such as generally illustrated in PCT application publication WO2023/0311903A1, which is also incorporated herein by reference in its entirety.

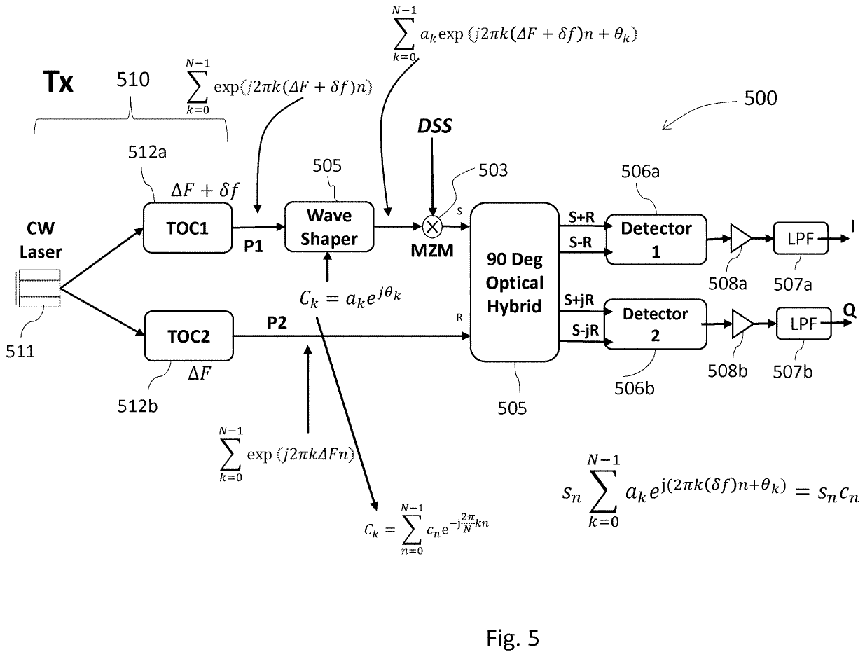

Reference is now made to FIG. 5, schematically illustrating a transmitter subsystem 500 of a wireless communication system, that uses a spreading code imprinting into one of two generated OFCs, each propagated via one of two optical paths P1 and P2, according to some embodiments.

The transmitter subsystem 500, may include:
an illumination unit 510 including a light source 511 such as a CW laser and two tunable optical frequency comb (TOC) devices such as a first TOC device 512a and a second TOC device 512b, for generating corresponding two different OFCs: a first OFC OFC1 and a second OFC OFC2, where the illumination unit 510 may also include one or more optical elements and/or devices for splitting light emanating from the light source 511 and/or for directing light from the light source 511 to each of the TOC devices 512a and 512b such as optical fibers (not shown), defining thereby a first optical path (FOP) P1 and a second optical path (SOP) P2;
a first optical modulator such as a first MZM 503 positioned over the FOP P1 and configured to introduce received signals (which include one or more de-spread or first spread signals of a narrower bandwidth BW1 or BW_{IM}) into the first OFC OFC1;
a wave shaper (WS) 504 configured to imprint a predefined spreading code into the first OFC OFC1 which is mixed with the incoming de-spread signal, where the combination of the first OFC—OFC1, the incoming de-spread signal and the imprinted spectral terms of the first OFC is outputted from the FOP P1;
a 90-degrees optical hybrid device 505 configured and positioned to receive signals S and R, outputted by each of the optical paths FOP P1 and SOP P2 (e.g., via different input ports thereof) and mix these signals (e.g., by integration and reduction thereof) such as to output two pairs of separate signals: a first pair of: M1=S+R and M2=S−R; and a second pair of: M3=S−jR and M4=S−jR;
two detectors such as: a first balanced detector 506a positioned and configured to receive the first signal pair M1 and M2; and a second balanced detector 506b positioned and configured to receive the second signal pair M3 and M4 and output two corresponding EOSs: EOS1 and EOS2;
two corresponding amplifiers 508a and 508b; and
two corresponding stretching devices 507a and 507b configured to receive and stretch corresponding two EOSs EOS1 and EOS2, outputted from the two balanced detectors 506a and 506b.

This transmitter subsystem 500 is aimed at spreading received/generated de-spread signal by imprinting spectral terms, each spectral term “k” (“k” being an integer number) may be described by: Cₖ=aₖe^{j6k} to the same optical path P1 which receives the incoming de-spread signal, to be spread.

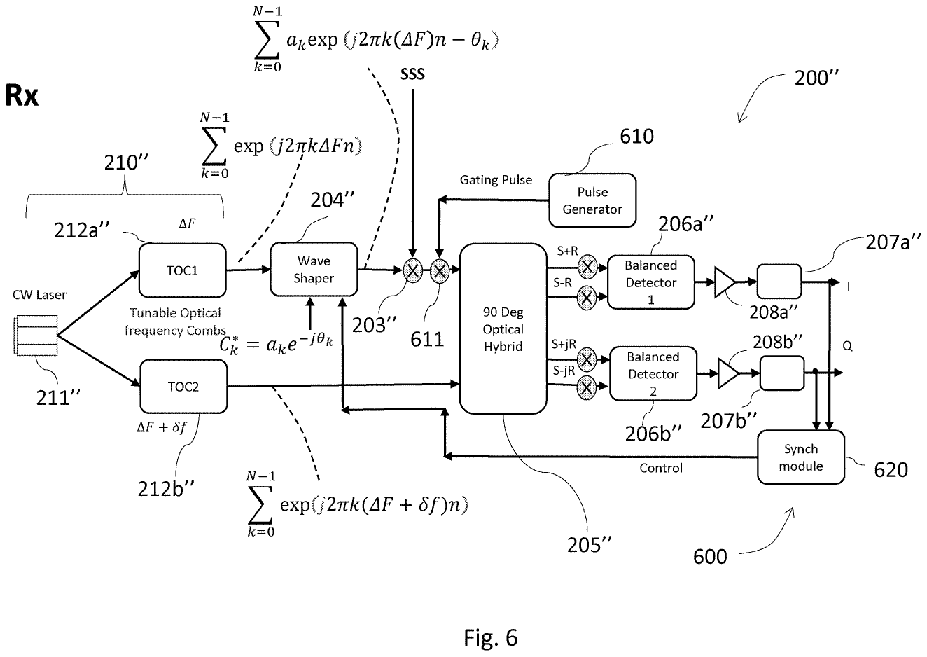

Reference is made to FIG. 6 showing a schematic illustration of a receiver subsystem 200″ for de-spreading received SSSs, that includes a synchronization subsystem 600 that is based on wave shaper 204″ control, according to other embodiments.

In this case, the receiver subsystem 200″ may include:
an illumination unit 210″ including a light source 211″ such as a CW laser and two tunable optical comb (TOC) devices such as a first TOC device 212a″ and a second TOC device 212b″, for generating corresponding two different OFCs: a first OFC OFC1 and a second OFC OFC2, where the illumination unit 210″ may also include one or more optical elements and/or devices for splitting light emanating from the light source 211″ and/or for directing light from the light source 21′1′ to each of the TOC devices 212a″ and 212b″ such as optical fibers (not shown), defining thereby a first optical path (FOP) P1 and a second optical path (SOP) P2;
a first optical modulator such as a first Mach Zehnder Modulator (MZM) 203″ positioned over the FOP P1 and configured to introduce received signals (which include one or more SSSs) into the first OFC OFC1;
a wave shaper (WS) 204″ configured to imprint a predefined spreading code into the first OFC OFC1;
a 90-degrees optical hybrid device 205″ configured and positioned to receive signals S and R, outputted by each of the optical paths FOP and SOP (e.g., via different input ports thereof) and mix these signals (e.g., by integration and reduction thereof) such as to output two pairs of separate signals: a first pair of: M1=S+R and M2=S−R; and a second pair of: M3=S−jR and M4=S−jR;
two detectors such as: a first balanced detector 206a;′ positioned and configured to receive the first signal pair S1 and S2; and a second balanced detector 206b;′ positioned and configured to receive the second signal pair S3 and S4 and output two corresponding EOSs: EOS1 and EOS2;
two corresponding amplifiers 208a″ and 208b″;
two corresponding stretching devices 207a″ and 207b″ configured to receive and stretch corresponding two EOSs EOS1 and EOS2, outputted from the two detectors 206a″ and 206b″; and
a synchronization subsystem 600 for synchronization between the received SSS timing and the spreading code imprinting timing that is based on pulses generation.

According to these embodiments, as shown in FIG. 6, the synchronization subsystem 600 may include:
a pulse generator 610 configured to generate repeated optical pulses;
a second (additional) modulator such as a second MZM 611 configured and positioned to introduce pulses generated by the pulse generator 610, into the signal propagated through the FOP P1; and
a synchronization module 620 configured to control spreading code imprinting and/or timing thereof by controlling the wave shaper 204″.

In these embodiments, pulse generator 610 introduces a sequence of similar/same gating pulses of same gating time and duration, where the timing of the comb propagated through FOP P1 is controllable for the synchronization thereof by controlling one or more properties of the spectral terms of the spreading code such as phase/or amplitude value of each spectral term of the spreading code being imprinted by controlling of the wave shaper 204″.

The serial search may be performed, in this case, similarly to the described for the receiver subsystem 200′ of FIG. 4, by repeatedly iterating the following steps for each serial search:
adjusting one or more parameter values of each of the spectral terms being imprinted onto comb modes of the first OFC—OFC1 that propagates through the FOP P1 such as phases, amplitudes and/or intensities of the comb modes of the first OFC-OFC1 (by controlling the wave shaper 204″); and
measuring the value of a criterion related parameter such as the signal strength (at the synchronization module 620) of EOSs outputted from the LPFs 207a″ and 207b″.

The synchronization may be done, in this case, by identifying one of the adjustments made to the first OFC—OFC1 that yielded corresponding EOSs' incoherent integration of maximal signal strength or minimum distance between the measured/determined EOSs signal strength and a predetermined threshold THss.

As mentioned above, one or more of the receiver subsystems described herein may be part a wireless communication system that may be based on multiple (such as double) cascaded spreading and/or multiple de-spreading such as generally illustrated in PCT application publication WO2023/0311903A1, which is also incorporated herein by reference in its entirety.

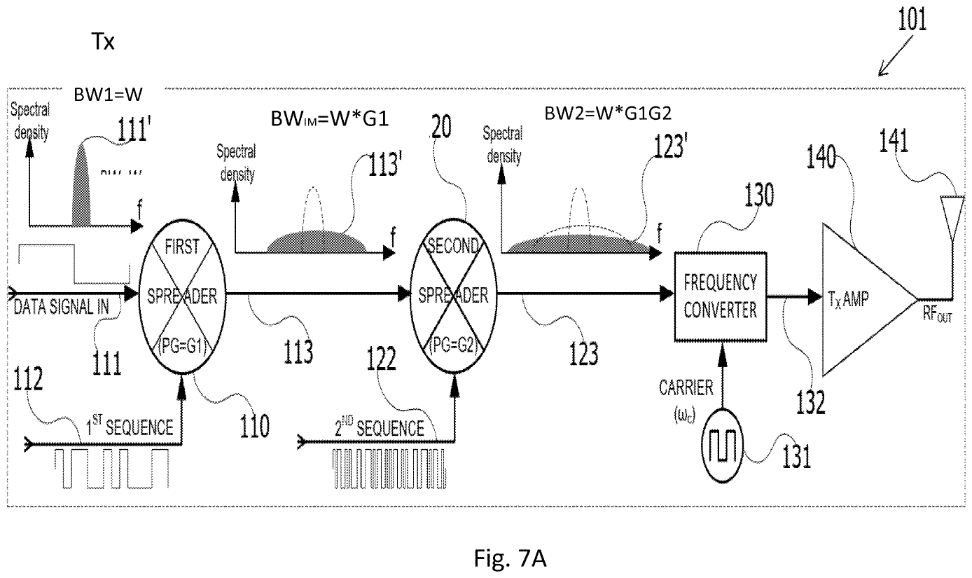

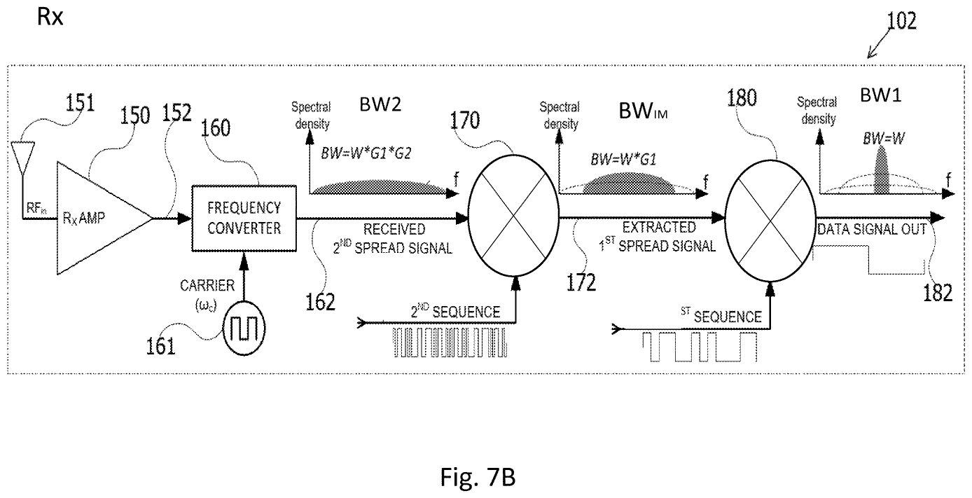

FIGS. 7A and 7B respectively illustrate main modules, devices and/or components of a transmitter Tx 101 and a receiver Rx 102 of a wireless communication system including at least one of each of these Tx 101 and Rx 102, based on a cascaded double spreading and de-spreading of signals, according to some embodiments.

As shown in FIG. 7A the Tx 101 may include:
a first-spreader 110, which may be configured to receive a data signal 111 such as an RF signal of the narrowest bandwidth of BW1 (having a frequency density as illustrated in graph 111′) and to perform a first spreading of the received data signal 111 (e.g., by using a first-spreading-sequence 112, thereby producing a first SSS1 113 of an intermediate bandwidth BW_{IM}>BW1 that is larger than the bandwidth of the received data signal 111, the first SSS1 113 may have a higher chip rate than that of the received data signal 111;
a second (optical) spreader 120 configured to multiply the SSS 113 by a second-spreading-sequence 122, thereby producing (generating) a double spread SSS2 123 of density as illustrated in graph 123′ and bandwidth that is significantly wider that of the received data signal 111 and also wider than the intermediate signal of SSS1 BW_{IM}: BW2>>BW1, such that BW2>BW_{IM}>BW1. The final double spread signal SSS2 123 has a higher chip rate than that of the first SSS1 113, which is therefore much greater than the chip rate of the first data signal 111.

Additionally, or alternatively, the transmitter (Tx) 101 may also include a frequency converter 130 and a carrier-generator 131 used for modulating/converting the double/multi SSS 123 into an RF double/multi SSS 132 in order to broadcast/transmit it with a transmission-amplifier 140 coupled by a transmission antenna 141.

According to some embodiments, the second spreader 120 of the Tx 101 may be based at least partially on optical spreading of the first SSS1 113 e.g., by imprinting spectral terms of a spreading code.

Reference is now made to FIG. 7B, schematically illustrating a receiver (Rx) 102 of a wireless communication system that uses double or multi cascaded (gradual) de-spreading of received SSSs for de-spreading of any type of received SSS such as double or multi spread SSSs such as SSS2 132, outputted from transmitters such as Tx 101.

The receiver (Rx) 102 may be configured to receive RF signals, having a very broad bandwidth BW2 such as higher than or up to 10 GHz, and decode/extract information, originated at the initial corresponding data signal thereof of a much narrower bandwidth BW1<<BW2.

The Rx 102 may be adapted for double-spreading high chip rate signals for the purpose of extracting information of a corresponding data signal, such as data signal 111.

According to some embodiments, the Rx 102 may include:
a first de-spreader 170, which may be an optical first de-spreader for conversion of each received broad SSS 162 of a widest bandwidth BW2 into an optical or electrical corresponding intermediate signal 172 of an intermediate bandwidth BW_{IM}<BW2; and
a second de-spreader 180 positioned and configured to further de-spread the intermediate signal 172 into an electrical/RF signal 182 of the narrowest bandwidth BW1 such that BW2>BW_{IM}>BW1 for decoding the actual data/information encoded by the received SSS.

According to some embodiments, the Rx 102 may also include a RF receiver amplifier (Rx-Amp) 150 coupled by a receiving antenna 151 adapted to receive an RF incoming SSS and amplify it generating thereby an amplified RF-SSS 152.

The Rx 102 may additionally or alternatively include a frequency-converter 160 and a carrier-generator 161 adapted to convert the amplified RF-SSS 152 into a converted SSS 162, of bandwidth BW2, used by the first de-spreader 170.

According to some embodiments, the first de-spreader 170 of the Rx 102 may at least include any one of the receiver subsystems 200, 200′ or 200″ of FIG. 2, 4 or 6, respectively.

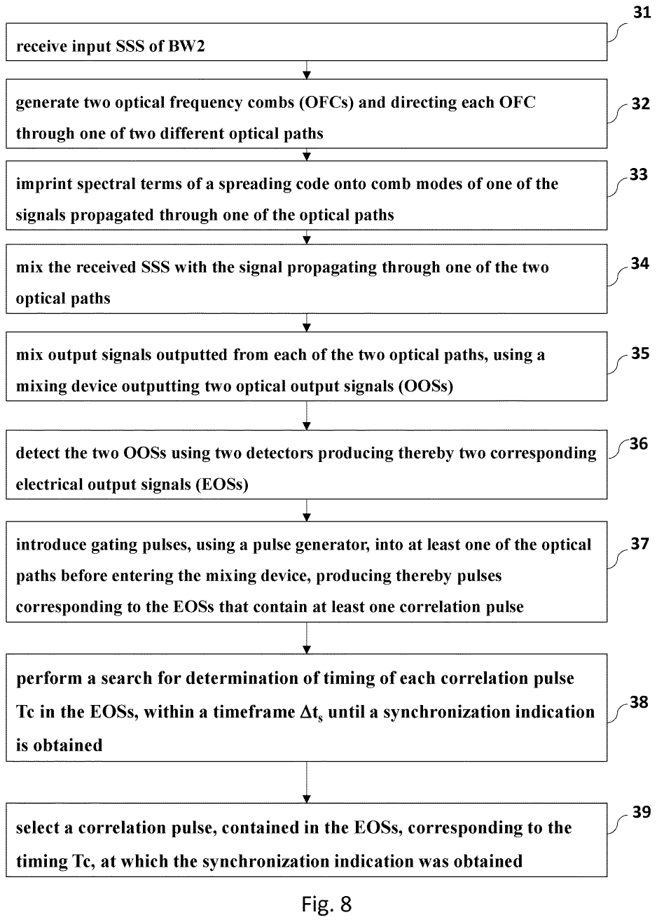

Reference is now made to FIG. 8, schematically illustrating main steps of a process/method for synchronized SSS de-spreading, according to some embodiments. The process may include:
receiving a SSS of a broad bandwidth of BW2 (step 31);
generating two optical frequency combs (OFCs) and directing each OFC through one of two different optical paths (step 32);
imprinting spectral terms of a spreading code onto comb modes of one of the signals propagated through one of the optical paths, producing thereby a coded optical frequency comb (step 33);
mixing each received SSS with the signal propagating through one of the two optical paths (step 34);
mixing output signals outputted from each of the two optical paths, using a mixing device outputting two optical output signals (OOSs) (step 35);
detecting the two OOSs using two detectors producing thereby corresponding two electrical output signals (EOSs) (step 36);
introducing periodic gating pulses, using a pulse generator, into at least one of the optical paths before entering the mixing device, producing thereby pulses corresponding to the EOSs that contain at least one correlation pulse (step 37); and
receiving and synchronizing de-spreading of the EOSs e.g., at least by:
performing a search for determination of timing of each correlation pulse Tc in the EOSs, within a timeframe Δtₛ until a synchronization indication is obtained (step 38); and
selecting at least one correlation pulse, contained in the EOSs, corresponding to the timing Tc, at which the synchronization indication was obtained, wherein each selected correlation pulse is the pulse selected for de-spreading thereof to a corresponding de-spread spectrum signal (DSS) of a bandwidth BW1, which is narrower than BW2 (step 39).

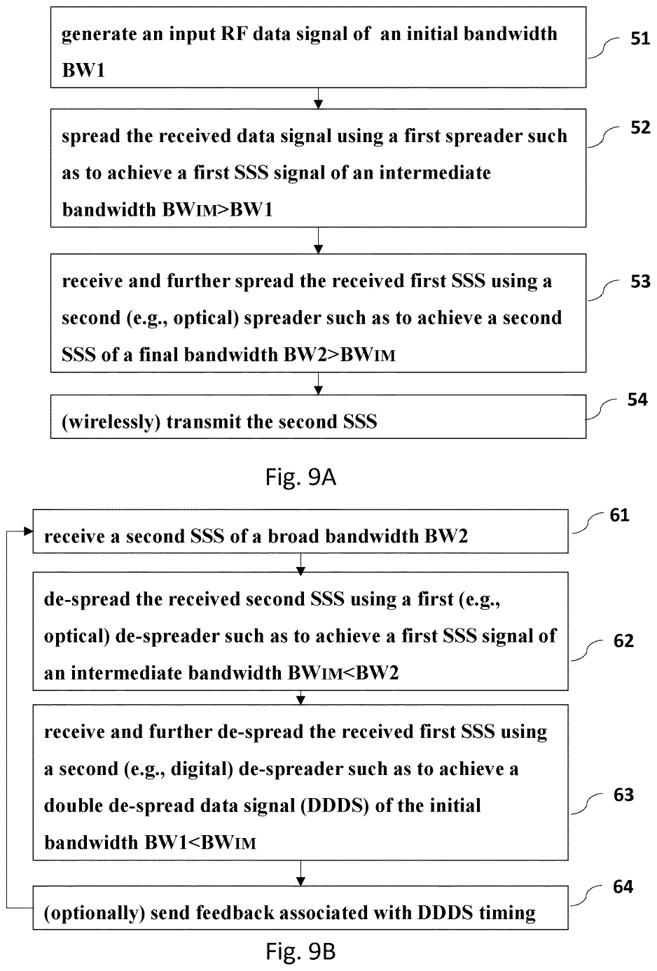

FIG. 9A schematically illustrates main steps of a spreading process using cascaded (gradual) multi-stage spreading of a received RF data signal of an initial narrow bandwidth BW1, carried out in a transmitter device of a wireless communication system according to some embodiments. This spreading process may include the following main general steps:
generating an input RF data signal of an initial bandwidth BW1 (step 51), e.g., by using one or more RF signals generators;
spreading the received RF data signal using a first spreader such as to achieve an intermediate SSS signal of an intermediate bandwidth BW_{IM}>BW1 (step 52);
receiving and further spreading the received first SSS using a second (e.g., optical) spreader such as to achieve a final SSS of a final bandwidth BW2>BW_{IM} (step 53); and
transmitting the second SSS via a wireless communication network (Step 54).

According to some embodiments, the second spreader may be designed such as to enable the second de-spreading of the intermediate signal, by imprinting a spreading code to the intermediate signal.

FIG. 9B schematically illustrates main steps of a de-spreading process using multi-stage (cascaded/gradual) de-spreading of a received second SSS of a broad bandwidth BW2, carried out in a receiver device of a wireless communication system according to some embodiments. This de-spreading process may include the following main general steps:
receiving a final SSS of a broad bandwidth BW2 (step 61);
de-spreading the received second SSS using a first de-spreader such as an optical de-spreader that may be designed to de-spread the received final SSS based on imprinting of a spreading code, achieving an intermediate SSS signal of an intermediate bandwidth BW_{IM}>BW1 (step 62); and
receiving and further de-spreading the intermediate SSS using a second (e.g., digital) de-spreader such as to achieve a double de-spread data signal (DDDS) of a final bandwidth BW1<BW_{IM}<BW2 (step 63).

According to some embodiments, the double de-spreading process may also optionally include sensing of a feedback associated with the timing of the digital signal processor (step 64) to be used for synchronizing the spreading code imprinting and generated gating pulses.

According to some embodiments, the first de-spreader may be implemented such as to enable synchronization between the received final SSS timing and the spreading code imprinting timing that is based on any one or more of the controllable gating-pulses generation-based techniques described above and/or based on any other synchronization techniques, such as, for example based on a feedback loop formed, enabling receiving feedback from the second de-spreader.

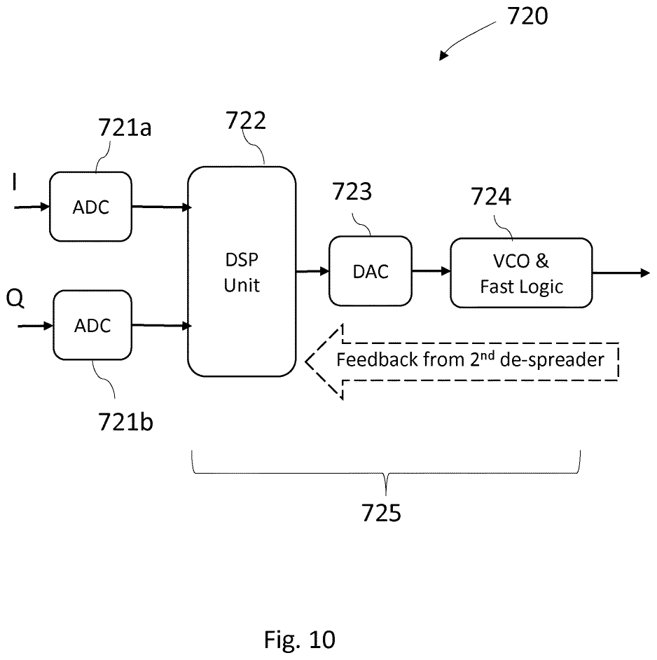

Reference is now made to FIG. 10 schematically illustrating a synchronization module 720 of an optical first de-spreader of a multi-stage de-spreading system, the optical first de-spreader using a two optical paths configuration such as any one of the receiving subsystems described above, where the synchronization module 720 uses feedback data/information/signals arriving from a second de-spreader to synchronize imprinting of a spreading code of an optical first de-spreader (that is based on spreading code imprinting), according to some embodiments. The synchronization module 720 may be similar in configuration to the synchronization module 320 described above.

The synchronization module 720 may include for example at least some of the following components:
two analogue-to-digital converters (ADCs), forming a complex SDC, such as a first ADC 721a configured to receive signals outputted from the first LPF of the first de-spreader and a second ADC 721b configured to receive signals outputted from the second LPF of the first de-spreader, where the two ADCs form together a single complex ADC; and
a search unit 725 that may include one or more digital and/or analogue hardware and/or software configured to receive output signals, outputted from the two ADCs 721a and 721b, and identify a timing Tc of a correlation pulse(s) based on feedback from the second de-spreader.

According to some embodiments, the search unit 725 may include, for example:
a DSP unit 722;
a digital-to-analogue converter (DAC) 723;
a voltage-controlled oscillator (VCO) 724 that may use or include fast-logic hardware and/or software.

According to some embodiments, the identification of the timing Tc of the correlation pulse(s) of each received final SSS, may be used for controlling spreading code imprinting by controlling gating timing of gating pulses introduced to signal propagated through one of the optical paths of the first de-spreader or by controlling properties such as timing, phase and/or amplitudes of spectral terms of the spreading code being imprinted to comb mode of a signal propagated through one of the optical path.

According to some embodiments, in which a serial search is performed to identify correlation pulse(s) timing(s), the synchronization module 720 may be configured to receive the de-spread signals outputted for LPFs of the first de-spreader, search for the peak of correlation through non-coherent integration of hypotheses of peak timing and control a gating pulses generator of the first de-spreader, by controlling gating-timing.

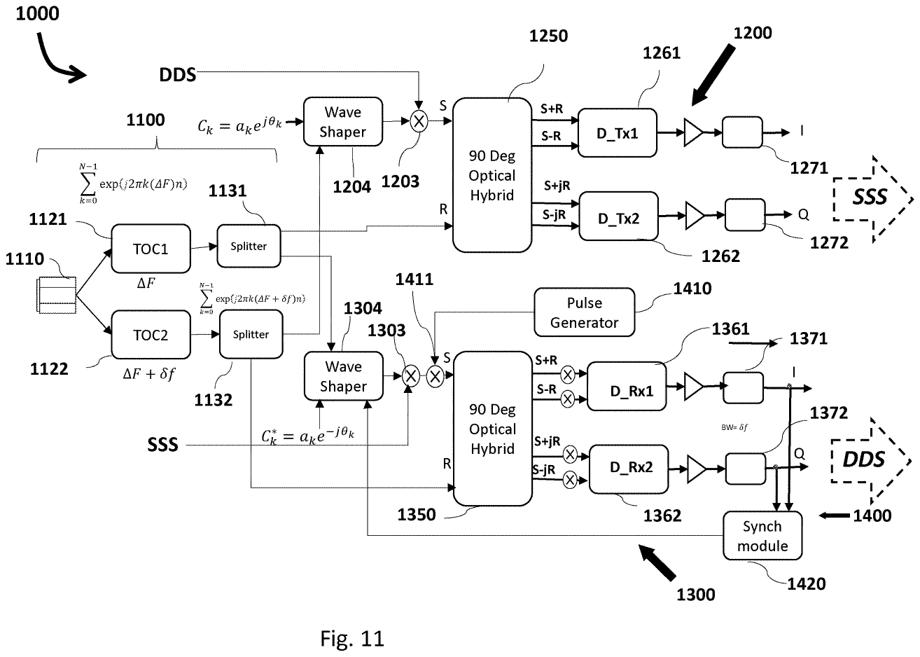

Reference is now made to FIG. 11, schematically illustrating main components of a transceiver subsystem 1000 enabling using a single mutual laser light source 1110 that can be used for both a transmitter Tx subsystem 1200 and a receiver Rx subsystem 1300, according to some embodiments.

According to some embodiments, the transceiver subsystem 1000 may be used as part of a transceiver system (not shown) that uses multi-stage spreading and/or de-spreading.

According to some embodiments, the transceiver subsystem 1000 may include the following main components:
an illumination unit 1100 that includes laser light source 1110, two TOC devices: a first TOC device 1121 and a second TOC device 1122, each TOC device being configured to generate a different OFC signal, and two splitting devices or elements such as a first splitter 1131 configured to split the first OFC—OFC1 outputted from the first TOC device 1121 and a second splitter 1132 configured to split the second OFC—OFC2 outputted from the second TOC device 1122;
a transmitter Tx subsystem 1200; and
a receiver Rx subsystem 1300.

According to some embodiments, as illustrated in FIG. 11, the OFC from the first OFC—OFC1 is split such that a first portion thereof is directed to be received by a transmitter (Tx) wave shaper 1204 of the Tx subsystem 1200, and a second portion thereof is directed to be received by a receiver Rx 90-degrees optical hybrid device 1350 of the Rx subsystem 1300; and the second OFC—OFC2 is split such that a first portion thereof is directed to be received by a Tx 90-degrees optical hybrid device 1250 of the Tx subsystem 1200, and a second portion thereof is directed to be received by a Rx wave shaper 1304 of the Rx subsystem 1300. In this way, each first OFC—OFC1 generated by the first TOC device 1121 is received at a corresponding 90-degrees optical hybrid device 1250/1350 of both the Tx and the Rx subsystems 1200 and 1300, and each second OFC—OFC2 generated by the second TOC device 1122 is received at a corresponding wave shaper 1204/1304 of both the Tx subsystem 1200 and the Rx subsystem 1300 of the transceiver subsystem 1000.

According to some embodiments, the Tx subsystem 1200 may include:
the Tx wave shaper 1204 configured for imprinting a spreading code to the second OFC—OFC2;
a MZM 1203 configured for mixing modified second OFC—OFC2 from the Tx wave shaper 1204 with a received data signal of an initial or intermediate waveband WB1/WB3;
the Tx 90-degrees optical hybrid device 1250 receiving a first OFC—OFC1 from the first TOC device 1121 of the illumination unit 1100;
two Tx detectors such as two balanced detectors: D_Tx1 1261 and D_Tx2 1262, each configured to detect signals outputted from a different pair of output ports of the Tx 90-degrees optical hybrid device 1250; and
two corresponding LPFs 1271 and 1272, each configured to receive (optionally amplified) EOS, outputted by a corresponding balanced detector 1261/1262.

In some embodiments, the Tx subsystem 1200 may be configured for a corresponding spreading of each received/generated RF data signal or intermediate signal of a lower frequency bandwidth BW1/BW_{IM} (in respect to the maximal spreading of a bandwidth BW2>BW_{IM}/BW1).

According to some embodiments, the Rx subsystem 1300 may include:
the Rx wave shaper 1304 configured for imprinting a spreading code to the second OFC—OFC2;
a MZM 1303 configured for mixing modified second OFC—OFC2 from the Rx wave shaper 1304 with a received signal of a bandwidth BW2>WB_{IM}>WB1;
the Rx 90-degrees optical hybrid device 1350 receiving a first OFC—OFC1 from the first TOC device 1121 of the illumination unit 1100;
Two Rx detectors such as two balanced detectors: D_Rx1 1361 and D_Rx2 1362, each configured to detect signals outputted from a different pair of output ports of the Tx 90-degrees optical hybrid device 1350;
two corresponding LPFs 1371 and 1372, each configured to receive (optionally amplified) EOS, outputted by a corresponding balanced detector 1361/1362; and
a synchronization subsystem 1400 including a pulse generator 1410, a synchronization MZM 1411, and a synchronization module 1420 that is operatively associated with the Rx wave shaper 1304 for controlling/adjusting code imprinting properties thereby.

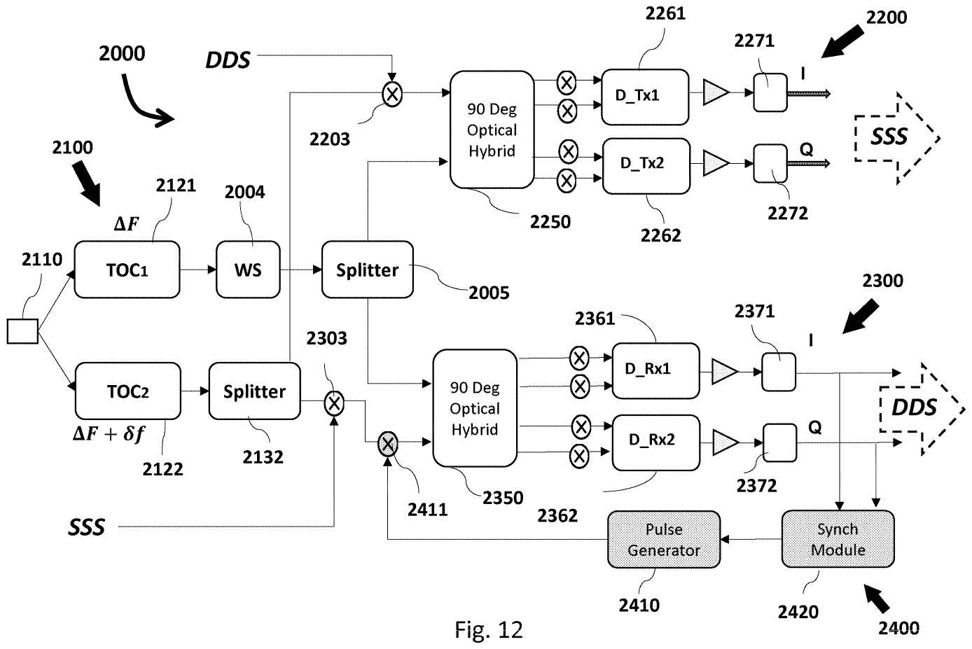

Reference is now made to FIG. 12, schematically illustrating main components of a transceiver subsystem 2000 enabling using a single mutual laser light source 2110 and a single mutual wave shaper 2004 that can be used for both a transmitter Tx subsystem 2200 and de-spreading receiver Rx subsystem 2300, according to some embodiments.

According to some embodiments, the transceiver subsystem 2000 may be used as part of a transceiver system (not shown) that uses multi-stage spreading and/or de-spreading.

According to some embodiments, the transceiver subsystem 2000 may include the following main components:
an illumination unit 2100 that includes at least one light source such as laser light source 2110, two TOC devices: a first TOC device 2121 and a second TOC device 2122, each TOC device being configured to generate a different OFC signal;
a mutual wave shaper 2004 configured to imprint a same spreading code onto comb modes of a first OFC—OFC1 outputted by the first TOC device 2121, and output a corresponding modified OFC—OFC1M;
two splitting devices or elements such as a first splitter 2131 configured to split the output signal outputted from the mutual wave shaper 2004 and a second splitter 2132 configured to split the second OFC—OFC2 outputted from the second TOC device 2122;
a transmitter Tx subsystem 2200; and
a receiver Rx subsystem 2300.

According to some embodiments, the Tx subsystem 2200 may include:
a Tx MZM 2203 configured for mixing the second OFC—OFC2 with a received/generated de-spread data signal (DDS) of an initial or intermediate waveband WB1/WB3 outputting a mixed OFC—OFCMIX_{Tx};
a Tx 90-degrees optical hybrid device 2250 configured for receiving the mixed OFC—OFCMIX_{Tx} at one input port thereof and the modified OFC—OFC1M from another input port thereof outputting four different output (optical) signals M1-M4 from its four output ports;
two Tx detectors such as two balanced detectors: D_Tx1 2261 and D_Tx2 2262, each configured to detect signals outputted from a different pair of output ports of the Tx 90-degrees optical hybrid device 2250; and
two corresponding LPFs 2271 and 2272, each configured to receive (optionally amplified) EOS, outputted by a corresponding balanced detector 2261/2262.

In some embodiments, the Tx subsystem 2200 may be configured for a corresponding spreading of each received/generated RF data signal or intermediate signal of a lower frequency bandwidth BW1/BW_{IM} (in respect to the maximal spreading of a bandwidth BW2>BW_{IM}/BW1).

According to some embodiments, the Rx subsystem 2300 may include:
a Rx MZM 2303 configured for mixing the second OFC—OFC2 emanating from the second TOC device 2122 with a received SSS of bandwidth WB2, outputting a mixed comb OFCMIX_{Rx},
a Rx 90-degrees optical hybrid device 2350 configured for receiving a signal emanating from the Rx MZM 2303 (optionally the mixed comb OFC2M_{Rx} further mixed alternately or occasionally with a gating pulse) and the modified comb OFC1M outputted from the mutual beam splitter 2005;
two Rx detectors such as two balanced detectors: D_Rx1 2361 and D_Rx2 12362, each configured to detect signals outputted from a different pair of output ports of the Rx 90-degrees optical hybrid device 2350;
two corresponding LPFs 2371 and 2372, each configured to receive (optionally amplified) EOS, outputted by a corresponding balanced detector 2361/2362; and
a synchronization subsystem 2400 including: a pulse generator 2410; a synchronization MZM 2411 for controllably/adjustably introducing gating pulses to the signal propagated through and/or outputted by the second optical path, emanating from the second TOC device 2122, and the second splitter 2132; and a synchronization module 2420 that is operatively associated with the pulse generator 2410 for controlling/adjusting timing and/or duration of gating/gating pulses generated by the pulse generator 2410 and introduced to be mixed with the signal propagated (e.g., outputted by) the second optical path.

According to some embodiments, any one or more RF generators may be used for generating the initial DDS for the TX subsystem 1200/2200.

According to some embodiments the Rx subsystem 1300 and/or 2300 and its corresponding synchronization subsystem 1400 and/or 2400, may be configured for serial search of correlation pulses timing and/or duration, based on incoherent integration of output signals outputted from the detectors and/or from the respective Rx 90-degrees optical hybrid device 1350 and/or 2350, e.g., where the identification of the correlation pulse(s) timing Tc is done by comparing integration results to a predefined threshold such as a predefined signal-strength threshold THss.

According to some embodiments, a frequency difference between each pair of adjacent tones of the first OFC—OFC1, generated by the first TOC device 1121/2121 is ΔF and the frequency difference between each pair of adjacent tones of the second OFC, generated by the second TOC device 1122/2122 is ΔF+δf, where δf<ΔF and optionally where ΔF≥N·δf, where N is an integer number equal to or larger than 1:N≥1.

According to some embodiments, the search for determining a timing of a correlation pulse Tc in the EOSs may be done by using a parallel search (instead of or in combination with a serial search), e.g., by simultaneously/parallelly performing incoherent integrations of each of several hypotheses of the timing Tc of the correlation pulse. This solution may require using more computation/processing power but may save computation/processing time and therefore synchronization time.

According to other embodiments, the DSP unit of the synchronization module 1420 and/or 2420 may be configured to perform a convolution-based signal stretching, where the Tx subsystem 2200 and/or the Rx subsystem 2300 of the transceiver subsystem 2000, do not require the LPFs 2271 and 2272 and/or 2371 and 2372.

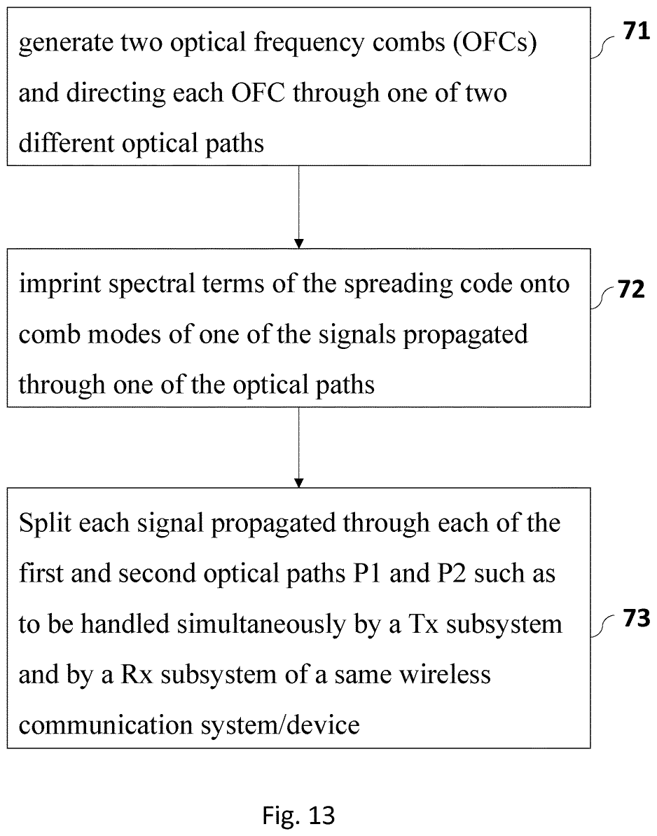

FIG. 13 schematically illustrates main steps of a process for using a same (mutual) laser light source and optionally other one or more devices such as a wave shaper for a transceiver device used for a wireless communication system used both as a spread-spectrum receiver and a transmitter, for a transceiver device that utilizes some of the receiver subsystem's modules/devices (of any design of receiver subsystem such as one or more of the receiver subsystem 200, 200′, 200″ as described above). This process may include at least the steps of:
generating two optical frequency combs (OFCs) and directing each OFC through one of two different optical paths (step 71);
imprinting spectral terms of the spreading code onto comb modes of one of the signals propagated through one of the optical paths (step 72); and
splitting each signal propagated through each of the first and second optical paths P1 and P2 such as to be handled simultaneously by a Tx subsystem and by a Rx subsystem of a same wireless communication system/device (step 73).

According to some embodiments, each signal outputted from each of the two optical paths is split (e.g., by one or more beam splitters or any other one or more dividing or splitting optical elements or devices) such that a portion thereof is directed to further components of a receiver subsystem such as a 90-degrees optical hybrid device and another portion of each of the output signals, is propagated to one or more optical and/or electronic components of a transmitter subsystem of the transceiver device.

### EXAMPLES

Example 1 is a transceiver subsystem for wireless communication comprising at least:
a transmitter (Tx) subsystem configured to spread obtained data signals (DSs) of frequency bandwidth BW1, generating spread spectrum signals (SSSs), each SSS having a higher frequency bandwidth BW2 than the frequency bandwidth BW1 of its corresponding obtained data signal (DS) and transmitting the generated SSSs;
a receiver (Rx) subsystem configured to receive SSSs, and de-spread received SSSs for achieving DSs of a narrower frequency bandwidth; and
an illumination unit, comprising at least one light source, the illumination unit being configured to generate optical frequency combs (OFCs) and direct each OFC or part thereof through one of at least two different optical paths, wherein the Tx Subsystem and the Rx subsystem use the same illumination unit and the same at least two OFCs generated by the illumination unit, for both spreading and de-spreading of signals, respectively.

In example 2, the subject matter of example 1 may include, wherein the Tx subsystem and/or the Rx subsystem comprises an optical spreading and/or de-spreading subsystems, respectively.

In example 3, the subject matter of any one or more of examples 1 to 2 may include, wherein the transceiver subsystem further comprises at least two splitters, wherein at least one splitter of the at least two splitters is configured to split a signal propagated via one of the at least two different optical paths and at least one other splitter of the at least two splitters is configured to split a signal propagated via a different optical path of the at least two different optical paths.

In example 4, the subject matter of any one or more of examples 1 to 3 may include, wherein the transceiver subsystem further comprises at least one wave shaper, each wave shaper being configured to imprint spectral terms of at least one spreading code or at least one de-spreading code onto comb modes of a signal propagated through at least one of the at least two different optical paths, producing thereby at least one coded optical frequency comb.

In example 5, the subject matter of any one or more of examples 1 to 4 may include, wherein a single wave shaper is used to generate a single coded optical frequency comb, which is then split for being fed to each of the Tx subsystem and the Rx subsystem, wherein the same code is used by the Tx subsystem and by the Rx subsystem.

In example 6, the subject matter of example 4 may include, wherein each of the Tx subsystem and the Rx subsystem uses a different wave shaper.

In example 7, the subject matter of any one or more of examples 4 to 6 may include, wherein:
the Tx subsystem comprises a modulator configured to receive the data signal and mix it with a signal outputted by the at least one wave shaper or with an OFC propagated via one of the at least two different optical paths; and
the Rx subsystem comprises a modulator configured to receive the SSS and mix it with a signal outputted by the at least one wave shaper or with an OFC propagated via one of the at least two different optical paths.

In example 8, the subject matter of any one or more of examples 1 to 7 may include, wherein:
the Tx subsystem comprises a Tx mixing device, configured to mix signals outputted from each of the at least two different optical paths of the Tx subsystem, outputting at least two corresponding Tx optical output signals (OOSs); and
the Rx subsystem comprises a Rx mixing device, configured to mix signals outputted from each of two different optical paths of the Rx subsystem, outputting at least two corresponding Rx OOSs.

In example 9, the subject matter of example 8 may include, wherein each of the Tx and the Rx mixing devices comprises a 90 degrees optical hybrid device.

In example 10, the subject matter of any one or more of examples 8 to 9 may include, wherein the Tx subsystem comprises at least two detectors each configured to detect one of the at least two OOSs outputted by the Tx mixing device and output two corresponding EOSs.

In example 11, the subject matter of any one or more of examples 8 to 10 may include, wherein the Rx subsystem further comprises at least two detectors, each configured to detect one of the at least two OOSs outputted by the Rx mixing device and output two corresponding electrical output signals (EOSs).

In example 12, the subject matter of any one or more of examples 8 to 11 may include, wherein the transceiver subsystem further comprises a synchronization subsystem comprising:
(i) a pulse generator configured to introduce gating pulses into at least one of the at least two different optical paths before entering the mixing device, producing thereby gating pulses corresponding to the EOSs that contain at least one correlation pulse; and
(ii) a synchronization module configured at least to:
receive and process pulses of the EOSs;
perform a search for determining a timing Tc of a correlation pulse in the EOSs, within a search timeframe Δtₛ, at which a synchronization indication is obtained; and
select at least one correlation pulse, contained in the EOSs, corresponding to the timing Tc, at which a synchronization indication was obtained, wherein the selected at least one correlation pulse is the pulse selected for de-spreading thereof to at least one de-spread spectrum signal (DSS) of a narrower bandwidth than that of the SSS.

In example 13, the subject matter of example 12 may include, wherein the synchronization module is configured to perform an integration of the received EOSs pulses within each given integration timeframe ΔTi, for determining timing Tc of each correlation pulse, based on best signal strength, wherein ΔTi>Δtₛ.

In example 14, the subject matter of example 13 may include, wherein the search performed is at least one of:
a serial search wherein the integration is carried out in a serial manner for at least some hypothetic correlation timings Tc and the timing of an integration result that has provided the best signal strength, is selected as the timing of the correlation pulse to be de-spread; and
a parallel search where integration is carried out in a parallel simultaneous manner for at least two hypothetic correlation timings Tc and the timing of an integration result that has provided the best signal strength is selected as the timing of the correlation pulse to be de-spread.

In example 15, the subject matter of any one or more of examples 12 to 14 may include, wherein the pulse generator is configured to generate gating pulses and is controllable by the synchronization module, and wherein the search is performed by shifting gating-timing of the gating pulses generated by the pulse generator, by a time step Tst, and performing the search for different gating-timings, until a synchronization indication is obtained.

In example 16, the subject matter of example 14 may include, wherein the search is performed by adjusting one or more parameters of the spreading code.

In example 17, the subject matter of example 16 may include, wherein the adjusting of the one or more properties of the spreading code comprises one or more of:
shifting timing of the spreading code; and/or
adjusting one or more parameters' values of one or more of the spectral terms of the spreading code being imprinted onto comb modes of the signal propagated through one of the at least two different optical paths, the one or more parameters' values being associated with phase and/or intensity of one or more of the spectral terms of the spreading code.

In example 18, the subject matter of any one or more of examples 1 to 17 may include, wherein the spectral terms of the spreading code are Discrete Fourier Transform (DFT) terms of the spreading code, or a conjugation of DFT terms of the spreading code.

In example 19, the subject matter of any one or more of examples 1 to 18 may include, wherein a frequency difference between each pair of adjacent tones of one of the two OFCs ΔF and the frequency difference between each pair of adjacent tones of the other OFC is at least ΔF+δf, such that ΔF≥N·δf, wherein “N” is an integer number larger than one, wherein δf is the bandwidth BW1 of the data signal, and wherein the bandwidth BW2 of the corresponding SSS is equal to or larger than N·δf.

In example 20, the subject matter of any one or more of examples 1 to 19 may include, wherein the Rx subsystem further comprises two detectors configured to receive signals outputted from a mixing device of the Rx subsystem and at least two stretching devices configured to receive and stretch corresponding two signals outputted from the two detectors.

In example 21, the subject matter of example 20 may include, wherein each stretching device comprises a low-pass filter (LPF), a balanced detector, or a convolution device configured for convolution of correlation pulses.

In example 22, the subject matter of any one or more of examples 1 to 21 may include, wherein: the Tx subsystem is configured for double spreading of received DSs; and/or the Rx subsystem is configured for double de-spreading of received SSSs.

In example 23, the subject matter of example 22 may include, wherein the Rx subsystem further comprises a first optical de-spreading subsystem (ODS) for performing an initial de-spreading of received at least one radio-frequency (RF) double-spread spectrum signal of frequency bandwidth BW2, outputting a corresponding de-spread data signal (DDS) of an intermediate bandwidth BW_{IM} which is narrower than BW2, wherein a second de-spreader of the receiver subsystem is configured to receive and further de-spread the SS of intermediate bandwidth BW_{IM} to a de-spread signal of a final bandwidth BW1, which is narrower than the intermediate bandwidth BW_{IM} of the DDS; and/or
wherein the Tx subsystem comprises a second spreader unit for receiving a firstly spread data signal, being spread by a first spreader outputting a first spread signal (SS) of an intermediate bandwidth BW_{IM} and further spreading the first SS to a final spread spectrum signal (SSS) of a bandwidth BW2 that is wider than that of the first SS WB_{IM}.

In example 24, the subject matter of any one or more of examples 1 to 23 may include, wherein the illumination unit comprises at least one light source and one or more optical elements and/or devices, configured to split and/or direct light emanating from the at least one light source to be propagated via two different optical paths.

In example 25, the subject matter of any one or more of examples 1 to 23, wherein each OFC is generated by using a different tunable optical frequency comb (TOC) device.

Example 26 is a method for wireless transmission and receiving of signals, the method comprising at least:
providing an illumination unit comprising at least one light source, wherein the illumination unit is configured to generate optical frequency combs (OFCs) and direct each OFC or part thereof through one of at least two different optical paths,
providing a transmission (Tx) subsystem and a receiver (Rx) subsystem;
obtaining, by the Tx subsystem, a data signal of a frequency bandwidth BW1;
generating a corresponding SSS, by the Tx subsystem, by spreading the obtained data signal, wherein the corresponding SSS is of a frequency bandwidth BW2, which is wider than frequency bandwidth BW1;
transmitting the generated corresponding SSS; and
receiving the transmitted SSS of frequency bandwidth BW2 and de-spreading it by the Rx subsystem, forming thereby a corresponding data signal of a frequency bandwidth BW1, which is narrower than BW2 of its corresponding SSS, wherein the method steps carried out by the Tx subsystem and by the Rx subsystem are carried out by using the same at least two OFCs generated by the illumination unit, for both spreading and de-spreading of signals, respectively.

In example 27, the subject matter of example 26 may include, wherein the method further comprises using at least two splitters, wherein at least one splitter of the at least two splitters, is configured to split a signal propagated via one of the at least two different optical paths and at least one other splitter of the at least two splitters is configured to split a signal propagated via a different optical path of the at least two different optical paths.

In example 28, the subject matter of any one or more of examples 26 to 27 may include, wherein the method further comprises imprinting spectral terms of at least one spreading code or at least one de-spreading code onto comb modes of a signal propagated through at least one of the at least two different optical paths, producing thereby at least one coded optical frequency comb, using at least one wave shaper.

In example 29, the subject matter of example 28 may include, wherein a single wave shaper is used to generate a single coded optical frequency comb, which is then split for being fed to each of the Tx subsystem and the Rx subsystem, wherein the same code is used by the Tx subsystem and by the Rx subsystem.

In example 30, the subject matter of any one or more of examples 28 to 29 may include, wherein each of the Tx subsystem and the Rx subsystem uses a different wave shaper.

In example 31, the subject matter of any one or more of examples 26 to 30 may include, wherein:
the Tx subsystem comprises a modulator configured to receive the data signal and mix it with a signal outputted by the at least one wave shaper or with an OFC propagated via one of the at least two different optical paths; and
the Rx subsystem comprises a modulator configured to receive the SSS and mix it with a signal outputted by the at least one wave shaper or with an OFC propagated via one of the at least two different optical paths.

In example 32, the subject matter of any one or more of examples 26 to 31 may include, wherein:
the Tx subsystem comprises a Tx mixing device, configured to mix signals outputted from each of two different optical paths of the Tx subsystem, outputting at least two corresponding Tx optical output signals (OOSs); and
the Rx subsystem comprises a Rx mixing device, configured to mix signals outputted from each of two different optical paths of the Rx subsystem, outputting at least two corresponding Rx OOSs.

In example 33, the subject matter of example 32 may include, wherein each of the Tx and the Rx mixing devices comprises a 90 degrees optical hybrid device.

In example 34, the subject matter of any one or more of examples 26 to 33 may include, wherein the Tx subsystem comprises at least two detectors each configured to detect one of the at least two OOSs outputted by the Tx mixing device and output two corresponding EOSs.

In example 35, the subject matter of any one or more of examples 25 to 33 may include, wherein the Rx subsystem further comprises:
two detectors, each configured to detect one of the at least two OOSs outputted by the Rx mixing device and output two corresponding electrical output signals (EOSs); and/or
a synchronization subsystem comprising:
(i) a pulse generator configured to introduce gating pulses into at least one of the at least two different optical paths before entering the mixing device, producing thereby gating pulses corresponding to the EOSs that contain at least one correlation pulse; and
(ii) a synchronization module configured at least to:
receive and process pulses of the EOSs;
perform a search for determining a timing Tc of a correlation pulse in the EOSs, within a search timeframe Δtₛ, at which a synchronization indication is obtained; and
select at least one correlation pulse, contained in the EOSs, corresponding to the timing Tc, at which a synchronization indication was obtained, wherein the selected at least one correlation pulse is the pulse selected for de-spreading thereof to at least one de-spread spectrum signal (DSS) of a narrower bandwidth than that of the SSS.

In example 36, the subject matter of example 35 may include, wherein the synchronization module is configured to perform an integration of the received EOSs pulses within each given integration timeframe ΔTi, for determining timing Tc of each correlation pulse, based on best signal strength, wherein ΔTi>Δtₛ.

In example 37, the subject matter of any one or more of examples 35 to 36 may include, wherein the search performed is at least one of:
a serial search wherein the integration is carried out in a serial manner for at least some hypothetic correlation timings Tc and the timing of an integration result that has provided the best signal strength, is selected as the timing of the correlation pulse to be de-spread; and
a parallel search where integration is carried out in a parallel simultaneous manner for at least two hypothetic correlation timings Tc and the timing of an integration result that has provided the best signal strength is selected as the timing of the correlation pulse to be de-spread.

In example 38, the subject matter of any one or more of examples 35 to 37 may include, wherein the pulse generator is configured to generate gating pulses and is controllable by the synchronization module, and wherein the search is performed by shifting gating-timing of the gating pulses generated by the pulse generator, by a time step Tst, and performing the search for different gating-timings, until a synchronization indication is obtained.

In example 39, the subject matter of example 38 may include, wherein the search is performed by adjusting one or more parameters of the spreading code.

In example 40, the subject matter of example 39 may include, wherein the adjusting of the one or more properties of the spreading code comprises one or more of:
shifting timing of the spreading code; and/or
adjusting one or more parameters' values of one or more of the spectral terms of the spreading code being imprinted onto comb modes of the signal propagated through one of the at least two different optical paths, the one or more parameters being associated with phase and/or intensity of one or more of the spectral terms of the spreading code.

In example 41, the subject matter of any one or more of examples 26 to 40 may include, wherein the spectral terms of the spreading code are Discrete Fourier Transform (DFT) terms of the spreading code, or a conjugation of DFT terms of the spreading code.

In example 42, the subject matter of any one or more of examples 26 to 41 may include, wherein a frequency difference between each pair of adjacent tones of one of the two OFCs ΔF and the frequency difference between each pair of adjacent tones of the other OFC is at least ΔF+δf, such that ΔF≥N·δf, wherein “N” is an integer number larger than one, wherein δf is the bandwidth BW1 of the data signal, and wherein the bandwidth BW2 of the corresponding SSS is equal to or larger than N·δf.

In example 43, the subject matter of any one or more of examples 26 to 42 may include, wherein the Rx subsystem further comprises two detectors configured to receive signals outputted from a mixing device of the Rx subsystem and at least two stretching devices configured to receive and stretch corresponding two signals outputted from the two detectors.

In example 44, the subject matter of example 43 may include, wherein each stretching device comprises a low-pass filter (LPF), a balanced detector, or a convolution device configured for convolution of correlation pulses.

In example 45, the subject matter of any one or more of examples 26 to 44 may include, wherein:
the Tx subsystem is configured for double spreading of received DSs; and/or
the Rx subsystem is configured for double de-spreading of received spread spectrum signals (SSSs).

In example 46, the subject matter of example 45 may include, wherein the Rx subsystem further comprises a first de-spreader unit comprising an ODS for performing an initial de-spreading of received at least one radio-frequency (RF) double-spread spectrum signal (SSS) of frequency bandwidth BW2, outputting a corresponding de-spread data signal (DDS) of an intermediate bandwidth BW_{IM} which is narrower than BW2, wherein a second de-spreader of the receiver subsystem is configured to receive and further de-spread the DDS; and/or wherein the Tx subsystem comprises a second spreader unit for receiving a firstly spread signal, being spread by a first spreader outputting a first SS of an intermediate bandwidth BW_{IM} and further spreading the first SS to a final spread spectrum signal (SSS) of a bandwidth BW2 that is wider than that of the first SS WB_{IM}.

In example 47, the subject matter of any one or more of examples 26 to 46 may include, wherein the illumination unit comprises at least one light source and one or more optical elements and/or devices, configured to split and/or direct light emanating from the at least one light source to be propagated via two different optical paths.

In example 48, the subject matter of any one or more of examples 26 to 47 may include, wherein each OFC is generated by using a different designated tunable optical frequency comb (TOC) device.

Example 49 is a receiver subsystem for de-spreading of at least one received spread spectrum signal (SSS), the receiver subsystem comprising at least:
(i) an optical de-spreading subsystem (ODS) comprising at least:
an illumination unit, comprising at least one light source, configured to generate two optical frequency combs (OFCs) and direct each OFC through one of two different optical paths;
a wave shaper, configured to imprint spectral terms of a spreading code onto comb modes of one of the signals propagated through one of the optical paths, producing thereby a coded optical frequency comb;
a first modulator, configured to mix each received SSS with the signal propagating through one of the two optical paths;
a mixing device, configured to mix output signals outputted from each of the two optical paths, outputting two optical output signals (OOSs);
two detectors, each configured to detect one of the two OOSs and output two corresponding electrical output signals (EOSs); and
(ii) a synchronization subsystem comprising at least:
a pulse generator configured to introduce gating pulses into one of the optical paths before entering the mixing device, producing thereby gating pulses corresponding to the EOSs that contain at least one correlation pulse; and
a synchronization module configured at least to:
receive and process pulses of the EOSs from the ODS;
perform a search for determining a timing of a correlation pulse Tc in the EOSs, within a search timeframe Δtₛ, at which a synchronization indication is obtained; and
select at least one correlation pulse, contained in the EOSs, corresponding to the timing Tc, at which the synchronization indication was obtained, wherein the selected at least one correlation pulse is the pulse selected for de-spreading thereof to at least one de-spread spectrum signal (DSS) of a narrower bandwidth than that of the SSS.

In example 50, the subject matter of example 49 may include, wherein the synchronization module is configured to perform an integration of the received EOSs pulses within each given integration timeframe ΔTi, for determining timing Tc of each correlation pulse, based on maximal signal strength, wherein ΔTi>Δts.

In example 51, the subject matter of example 50 may include, wherein the search performed is at least one of: a serial search wherein the integration is carried out in a serial manner for at least some of the hypothetic correlation timings Tc and the timing of the integration result that has provided the best signal strength is selected as the timing of the correlation signal to be de-spread; and/or a parallel search wherein the integration is carried out in a parallel simultaneous manner for at least two hypothetic correlation timings Tc and the timing of the integration result that has provided the best strength is selected as the timing of the correlation signal to be de-spread.

In example 52, the subject matter of any one or more of examples 49 to 51 may include, wherein the pulse generator is configured to generate gating pulses and is controllable by the synchronization module, and wherein the search is performed by shifting gating-timing of the gating pulses generated by the pulse generator, by a time step Tst, and performing the search for different gating-timings, until a synchronization indication is obtained.

In example 53, the subject matter of any one or more of examples 49 to 51 may include, wherein the search is performed by adjusting one or more properties of the spreading code.

In example 54, the subject matter of example 53 may include, wherein the adjusting of the one or more properties of the spreading code comprises one or more of: shifting imprinting timing of the spreading code; and/or adjusting one or more parameters' values of one or more of the spectral terms of the spreading code being imprinted onto comb modes of the signal propagated through one of the optical paths, the one or more parameters being associated with phase and/or intensity of one or more of the spectral terms of the spreading code.

In example 55, the subject matter of any one or more of examples 49 to 54 may include, wherein the spectral terms of the spreading code are Discrete Fourier Transform (DFT) terms of the spreading code, or a conjugation of DFT terms of the spreading code.

In example 56, the subject matter of any one or more of examples 49 to 55 may include, wherein the bandwidth BW2 of each SSS is of a frequency bandwidth of ΔF, which is a multiplication of a bandwidth BW1=δf of the de-spread signal such that ΔF≥N·δf, wherein “N” is an integer number.

In example 57, the subject matter of example 56 may include, wherein a frequency difference between each pair of adjacent tones of one of the two OFCs is at least ΔF and the frequency difference between each pair of adjacent tones of the other OFC is at least ΔF+δf.

In example 58, the subject matter of any one or more of examples 49 to 57 may include, wherein the receiver subsystem further comprises a second modulator for mixing the periodic gating pulses with signals propagating through one of the two optical paths.

In example 59, the subject matter of any one or more of examples 49 to 58 may include, wherein the receiver subsystem further comprises at least two stretching devices configured to receive and stretch corresponding two EOSs outputted from the two detectors.

In example 60, the subject matter of example 59 may include, wherein each stretching device comprises a low-pass filter (LPF) or a convolution device configured for convolution of correlation pulses.

In example 61, the subject matter of any one or more of examples 59 to 60 may include, wherein the ODS comprises at least two amplifiers, each amplifier being located between the output of a different detector and an input of a corresponding stretching device, each amplifier being configured for signal amplification and/or for signal-to-noise ratio (SNR) improvement of the EOSs outputted from the corresponding detector.

In example 62, the subject matter of any one or more of examples 49 to 61 may include, wherein the mixing device comprises a 90-degrees optical hybrid device.

In example 63, the subject matter of any one or more of examples 49 to 62 may include, wherein each detector comprises at least one of: at least one balanced detector.

In example 64, the subject matter of any one or more of examples 49 to 63 may include, wherein the synchronization module comprises at least:
two analogue-to-digital converters (ADCs) forming together a single complex ADC, each ADC being configured for receiving a different input signal emanating from a corresponding detector; and/or
a search unit comprising digital and/or analogue hardware and/or software configured to receive output signals, outputted from the two ADCs and perform a serial and/or a parallel search for the determination of the timing Tc of each correlation pulse.

In example 65, the subject matter of example 64 may include, wherein the search unit comprises a digital signal processing (DSP) unit, a digital-to-analogue converter (DAC), a voltage-controlled oscillator (VCO) and fast-logic hardware and/or software.

In example 66, the subject matter of any one or more of examples 64 to 65 may include, wherein the search unit is configured to perform the serial search by using an integration of the received and converted input signals, emanating from the detectors, and determining correlation pulse timing Tc location based on maximal signal strength.

In example 67, the subject matter of any one or more of examples 49 to 66 may include, wherein the receiver subsystem is part of a wireless transceiver system configured for both receiving, de-spreading and decoding SSSs as well as for generation, spreading and transmission of SSSs.

In example 68, the subject matter of example 67 may include, wherein the transceiver system uses the same light source for generating the same two OFCs for both spreading of each signal to be transmitted and de-spreading of each received SSS.

In example 69, the subject matter of any one or more of examples 67 to 68 may include, wherein the transceiver system further comprises one or more beam splitting elements for splitting each of the generated OFCs for being used for spreading and for de-spreading, enabling simultaneous utilization of the light source.

In example 70, the subject matter of any one or more of examples 49 to 69 may include, wherein the timing of each correlation pulse Tc is determined based on comparing result of an integration of multiple EOSs pulses to at least one predefined threshold value.

In example 71, the subject matter of any one or more of examples 49 to 70 may include, wherein the receiver subsystem is part of a receiver unit for wireless communication, wherein the receiver unit further comprises a first de-spreader unit for performing an initial de-spreading of received at least one radio-frequency (RF) double-spread spectrum signals of frequency bandwidth BW2, outputting a corresponding SSS of an intermediate bandwidth BW_{IM} which is narrower than BW2, wherein the ODS of the receiver subsystem is configured to receive and further de-spread the intermediate SSS of bandwidth BW_{IM} to a de-spread signal of a final bandwidth BW1, which is narrower than the bandwidth BW_{IM} of the intermediate SSS.

In example 72, the subject matter of example 71 may include, wherein the synchronization subsystem is configured to determine timing Tc of each correlation pulse, based at least on timing of the double-spread spectrum signal, received from the first de-spreader.

In example 73, the subject matter of any one or more of examples 49 to 72 may include, wherein the wave shaper is located and configured to manipulate a first OFC propagating through a first optical path that also receives the at least one SSS via the first modulator.

In example 74, the subject matter of any one or more of examples 49 to 73 may include, wherein the wave shaper is located and configured to manipulate a second OFC propagating through a second optical path from the two optical paths, that does not receive the at least one SSS, wherein each SSS is received and mixed with a first OFC propagated through the other first optical path, from the two optical paths.

In example 75, the subject matter of any one or more of examples 49 to 74 may include, wherein the illumination unit comprises at least one light source and one or more optical elements and/or devices, configured to split and/or direct light emanating from the laser light source to be propagated via the two optical paths.

In example 76, the subject matter of any one or more of examples 49 to 75 may include, wherein the receiver subsystem further comprises at least two optical waveguides forming two channels forming the two optical paths.

In example 77, the subject matter of any one or more of examples 49 to 76 may include, wherein each OFC is generated by using a different designated optical modulator.

In example 78, the subject matter of any one or more of examples 49 to 77 may include, wherein the first modulator is a Mach Zehnder Modulator (MZM).

Example 79 is a method for de-spreading at least one received spread spectrum signal (SSS), the method comprising at least:
receiving the at least one SSS;
generating two optical frequency combs (OFCs) and directing each OFC through one of two different optical paths;
imprinting spectral terms of a spreading code onto comb modes of one of the signals propagated through one of the optical paths, producing thereby a coded optical frequency comb;
mixing each received SSS with the signal propagating through one of the two optical paths;
mixing output signals outputted from each of the two optical paths, using a mixing device outputting two optical output signals (OOSs); and
detecting the two OOSs using two detectors producing thereby corresponding two electrical output signals (EOSs);
introducing periodic gating pulses, using a pulse generator, into at least one of the optical paths before entering the mixing device, producing thereby pulses corresponding to the EOSs that contain at least one correlation pulse; and
receiving and synchronizing de-spreading of the EOSs at least by:
performing a search for determination of timing of each correlation pulse Tc in the EOSs, within a timeframe Δtₛ until a synchronization indication is obtained; and
selecting at least one correlation pulse, contained in the EOSs, corresponding to the timing Tc, at which the synchronization indication was obtained, wherein each selected correlation pulse is the pulse selected for de-spreading thereof to a corresponding de-spread spectrum signal (DSS), which is a de-spread data signal (DDS) of a bandwidth which is narrower than the bandwidth of the SSS.

In example 80, the subject matter of example 79 may include, wherein the search performed is a serial and/or a parallel search.

In example 81, the subject matter of any one or more of examples 79 to 80 may include, wherein the synchronizing further comprises performing integration of the received EOSs pulses within each given integration timeframe ΔTi, for determining timing Tc of each correlation pulse, based on maximal signal strength, wherein ΔTi>Δtₛ.

In example 82, the subject matter of example 81 may include, wherein the integration of the received EOSs pulses is done by comparing the incoherent integration result to a predefined threshold.

In example 83, the subject matter of any one or more of examples 79 to 82 may include, wherein the step of imprinting spectral terms of the spreading code is done by using a wave shaper.

In example 84, the subject matter of any one or more of examples 79 to 83 may include, wherein the search is performed by shifting gating-timing of the periodic gating pulses, by a time step Ts, and repeating the search.

In example 85, the subject matter of any one or more of examples 79 to 84 may include, wherein the search is performed by shifting and/or selecting amplitudes and/or phases of the spectral terms being imprinted onto comb modes of one of the signals propagated through one of the optical paths.

In example 86, the subject matter of any one or more of examples 79 to 85 may include, wherein the determining of each correlation pulse timing Tc location is based on maximal signal strength.

In example 87, the subject matter of any one or more of examples 79 to 86 may include, wherein the method further comprises initial steps of:
In example 88, the subject matter of examples 79 to 87 may include, wherein the method further comprises initial steps of:
receiving a stretched signal of an intermediate frequency bandwidth BW_{IM}, which was stretched according to the steps of claim 39;
further de-spreading of each received stretched signal by a second de-spreader; and
outputting a double de-spread data signal of bandwidth BW1, which is narrower than the intermediate bandwidth BW_{IM} of the stretched signal.

In example 89, the subject matter of example 87 may include, wherein the determining of the timing Tc of each correlation pulse is based at least on timing of the corresponding double de-spread data signal, received from the second de-spreader.

In example 90, the subject matter of any one or more of examples 79 to 89 may include, wherein the search for determining a timing of a correlation pulse Tc in the EOSs is done by using a parallel and/or a serial search.

Unless specifically stated otherwise, as apparent from the above discussions, it is appreciated that throughout the specification discussions utilizing terms such as “obtaining”, “identifying”, “determining” “performing”, “providing” “moving”, “instructing”, “estimating”, “calculating” and the like, include action and/or processes of a computer/processor(s) that manipulate and/or transform data into other data, said data represented as physical quantities, e.g., such as electronic quantities, and/or said data representing the physical objects. The terms “computer”, “processor”, “processing resource”, “processing circuitry”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g., digital signal processing (DSP) unit, a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter.

Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

Any reference in the specification to a method should be applied mutatis mutandis to a system capable of executing the method and should be applied mutatis mutandis to a non-transitory computer readable medium that stores instructions that once executed by a computer result in the execution of the method. Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

While the invention has been described with respect to a limited number of embodiments, these should not be construed as limitations on the scope of the invention, but rather as exemplifications of some of the embodiments.

Any digital computer system, unit, device, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may directly loadable into an internal memory of a digital computer, comprising software code portions for performing the methods and/or processes as disclosed herein.

Additionally or alternatively, the methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” encompasses distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

These computer readable and executable instructions may be provided to a processor of a general-purpose-computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable and executable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

A module, a device, a mechanism, a unit and or a subsystem may each comprise a machine or machines executable instructions (e.g., commands). A module may be embodied by a circuit or a controller programmed to cause the system to implement the method, process and/or operation as disclosed herein. For example, a module may be implemented as a hardware circuit comprising, e.g., custom very large-scale integration (VLSI) circuits or gate arrays, an application-specific integrated circuit (ASIC), off-the-shelf semiconductors such as logic chips, transistors, and/or other discrete components. A module may also be implemented in programmable hardware devices such as field programmable gate arrays, programmable array logic, programmable logic devices and/or the like.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

Unless otherwise specified, the terms “substantially”, “about” and/or “close” with respect to a magnitude or a numerical value may imply to be within an inclusive range of −10% to +10% of the respective magnitude or value.

It is important to note that the method may include is not limited to those diagrams or to the corresponding descriptions. For example, the method may include additional or even fewer processes or operations in comparison to what is described in the figures. In addition, embodiments of the method are not necessarily limited to the chronological order as illustrated and described herein.

Discussions herein utilizing terms such as, for example, “processing”, “computing”, “calculating”, “determining”, “establishing”, “analyzing”, “checking”, “estimating”, “deriving”, “selecting”, “inferring” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes. The term determining may, where applicable, also refer to “heuristically determining”.

It should be noted that where an embodiment refers to a condition of “above a threshold”, this should not be construed as excluding an embodiment referring to a condition of “equal or above a threshold”. Analogously, where an embodiment refers to a condition “below a threshold”, this should not be construed as excluding an embodiment referring to a condition “equal or below a threshold”. It is clear that should a condition be interpreted as being fulfilled if the value of a given parameter is above a threshold, then the same condition is considered as not being fulfilled if the value of the given parameter is equal or below the given threshold. Conversely, should a condition be interpreted as being fulfilled if the value of a given parameter is equal or above a threshold, then the same condition is considered as not being fulfilled if the value of the given parameter is below (and only below) the given threshold.

It should be understood that where the claims or specification refer to “a” or “an” element and/or feature, such reference is not to be construed as there being only one of those elements. Hence, reference to “an element” or “at least one element” for instance may also encompass “one or more elements”.

Terms used in the singular shall also include the plural, except where expressly otherwise stated or where the context otherwise requires.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Unless otherwise stated, the use of the expression “and/or” between the last two members of a list of options for selection indicates that a selection of one or more of the listed options is appropriate and may be made. Further, the use of the expression “and/or” may be used interchangeably with the expressions “at least one of the following”, “any one of the following” or “one or more of the following”, followed by a listing of the various options.

It is appreciated that certain features of the invention, which are, for clarity, described in the context of separate embodiments or example, may also be provided in combination in a single embodiment. Conversely, various features of the invention, which are, for brevity, described in the context of a single embodiment, example and/or option, may also be provided separately or in any suitable sub-combination or as suitable in any other described embodiment, example or option of the invention. Certain features described in the context of various embodiments, examples and/or optional implementation are not to be considered essential features of those embodiments, unless the embodiment, example and/or optional implementation is inoperative without those elements.

It is noted that the terms “in some embodiments”, “according to some embodiments”, “according to some embodiments of the invention”, “for example”, “e.g.,”, “for instance” and “optionally” may herein be used interchangeably.

The number of elements shown in the Figures should by no means be construed as limiting and is for illustrative purposes only.

It is noted that the terms “operable to” can encompass the meaning of the term “modified or configured to”. In other words, a machine “operable to” perform a task can in some embodiments, embrace a mere capability (e.g., “modified”) to perform the function and, in some other embodiments, a machine that is actually made (e.g., “configured”) to perform the function.

Throughout this application, various embodiments may be presented in and/or relate to a range format. It should be understood that the description in range format is merely for convenience and brevity and should not be construed as an inflexible limitation on the scope of the embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

1. A system for wireless communication comprising at least:
a transmitter (Tx) subsystem configured to:
spread at least one obtained data signal of a first frequency bandwidth, generating at least one spread spectrum signal (SSS), each SSS having a second frequency bandwidth that is wider than the first frequency bandwidth of its corresponding obtained data signal; and
transmit the generated at least one SSS; and
an illumination unit, comprising at least one light source, the illumination unit being configured to generate at least two optical frequency combs (OFCs) and direct each OFC or a part thereof through one of at least two different optical paths,
wherein the Tx subsystem uses the illumination unit and the at least two OFCs generated by the illumination unit, for spreading the at least one obtained data signal.

2. The system of claim 1, further comprising:
a receiver (Rx) subsystem configured to receive at least one second SSS of the second frequency bandwidth, and de-spread the received at least one second SSS for achieving at least one de-spread signal of the first frequency bandwidth.

3. The system of claim 2, wherein the Rx subsystem uses the illumination unit and the at least two OFCs generated by the illumination unit, for de-spreading the received at least one second SSS.

4. The system of claim 2, wherein the Rx subsystem comprises a Rx wave shaper that is configured to imprint spectral terms of at least one de-spreading code onto comb modes of one of the at least two OFCs, producing thereby at least one coded optical frequency comb.

5. The system of claim 1, wherein the Tx subsystem comprises a Tx wave shaper that is configured to imprint spectral terms of at least one spreading code onto comb modes of one of the at least two OFCs, producing thereby at least one coded optical frequency comb.

6. The system of claim 4, wherein the Rx subsystem is configured to: adjust one or more parameters' values of one or more of the spectral terms of the de-spreading code, the one or more parameters' values being associated with phase and/or intensity of one or more of the spectral terms of the de-spreading code.

7. The system of claim 2, wherein the Rx subsystem is configured for double de-spreading.

8. The system of claim 7, wherein the received at least one second SSS is a radio-frequency (RF) double-spread spectrum signal, and wherein the Rx subsystem includes a second de-spreader that is configured to receive and further de-spread the de-spread signal to generate an electrical or RF signal of a final frequency bandwidth, which is narrower than the first frequency bandwidth.

9. The system of claim 1, wherein:
the Tx subsystem is configured for double spreading.

10. The system of claim 9, wherein the at least one obtained data signal is a firstly spread data signal, and wherein the Tx subsystem includes a first spreader that is configured to spread a data signal of a narrower bandwidth, narrower than the first frequency bandwidth, to generate the firstly spread data signal.

11. A method for wireless communication, the method comprising at least:
providing an illumination unit comprising at least one light source, wherein the illumination unit is configured to generate at least two optical frequency combs (OFCs) and direct each OFC or a part thereof through one of at least two different optical paths;
providing a transmission (Tx) subsystem;
obtaining, by the Tx subsystem, a data signal of a first frequency bandwidth;
generating a corresponding spread spectrum signal (SSS), by the Tx subsystem, by spreading the obtained data signal, wherein the corresponding SSS is of a second frequency bandwidth that is wider than the first frequency bandwidth; and
transmitting the generated corresponding SSS;
wherein the corresponding SSS is generated using the at least two OFCs generated by the illumination unit.

12. The method of claim 11, further comprising:
providing a receiver (Rx) subsystem; and
receiving a second SSS of the second frequency bandwidth and de-spreading the second SSS by the Rx subsystem, generating thereby a corresponding de-spread signal of the first frequency bandwidth.

13. The method of claim 12, wherein the corresponding de-spread signal is generated using the at least two OFCs generated by the illumination unit.

14. The method of claim 12, wherein de-spreading the second SSS comprises:
imprinting spectral terms of at least one de-spreading code onto comb modes of one of the at least two OFCs, by a Rx wave shaper of the Rx subsystem, producing thereby at least one coded optical frequency comb.

15. The method of claim 11, wherein spreading the obtained data signal comprises:
imprinting spectral terms of at least one spreading code onto comb modes of one of the at least two OFCs, by a Tx wave shaper of the Tx subsystem, producing thereby at least one coded optical frequency comb.

16. The method of claim 14, further comprising:
adjusting one or more parameters' values of one or more of the spectral terms of the de-spreading code, the one or more parameters being associated with phase and/or intensity of one or more of the spectral terms of the de-spreading code.

17. The method of claim 12, wherein the Rx subsystem is configured for double de-spreading.

18. The method of claim 17, wherein the received at least one second SSS is a radio-frequency (RF) double-spread spectrum signal (SSS), and wherein the method further comprises:
receiving and further de-spreading the de-spread signal, by a second de-spreader of the Rx subsystem, to generate an electrical or RF signal of a final frequency bandwidth, which is narrower than the first frequency bandwidth.

19. The method of claim 11, wherein:
the Tx subsystem is configured for double spreading.

20. The method of claim 19, wherein the at least one obtained data signal is a firstly spread data signal, and wherein the method further comprises:
spreading a narrower bandwidth data signal that is of a narrower bandwidth than the first frequency bandwidth, by a first spreader of the Tx subsystem, to generate the firstly spread data signal.
